(19) United States
(12) Patent Application Publication
(10) Pub. No.: US 2025/0192852 A1
(43) Pub. Date: Jun. 12, 2025

(54) DIFFERENTIAL CHANNEL STATE INFORMATION REPORT

(71) Applicant: QUALCOMM INCORPORATED, San Diego, CA (US)

(72) Inventors: Min Huang, Beijing (CN); Liangming Wu, Beijing (CN); Jing Dai, Beijing (CN); Chenxi Hao, Beijing (CN); Wei Xi, Beijing (CN); Chao Wei, Beijing (CN); Hao Xu, Beijing (CN)

(21) Appl. No.: 18/840,228

(22) PCT Filed: Apr. 28, 2022
(86) PCT No.: PCT/CN2022/089756

§ 371 Date: Aug. 21, 2024

(51) Int. Cl. H04B 7/06; H04L 5/00

(52) U.S. Cl. CPC H04B 7/0641; H04B 7/0626; H04L 5/0048

(57) ABSTRACT

Methods, systems, and devices for wireless communications are described. A user equipment (UE) may receive a message that indicates a channel state information (CSI) report configuration that identifies a quantity of CSI reports to be transmitted by the UE. The UE may generate, based on the CSI report configuration, a full CSI report and one or more partial CSI reports. The full CSI report may include at least a set of spatial domain basis functions and a set of channel coefficients associated with the set of spatial domain basis functions. The one or more partial CSI reports each include a respective set of differential channel coefficients. The UE may transmit the quantity of CSI reports. The quantity of CSI reports may include the full CSI report and the one or more partial CSI reports.

### CROSS REFERENCE

The present Application is a 371 national stage filing of International PCT Application No. PCT/CN2022/089756 by Huang et al. entitled “DIFFERENTIAL CHANNEL STATE INFORMATION REPORT,” filed Apr. 28, 2022, which is assigned to the assignee hereof, and which is expressly incorporated by reference in its entirety herein.

### FIELD OF TECHNOLOGY

The following relates to wireless communications, including differential channel state information (CSI) reports.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipment (UE). In some wireless communications systems, a UE may perform channel estimation and report parameters associated with the estimated channel to a network entity. The network entity may use the reported parameters to improve the capacity of the channel through adaptive techniques, such as channel precoding, interference mitigation, and signal rank determination. In some cases, existing techniques for reporting parameters associated with an estimated channel may be deficient.

### SUMMARY

The described techniques relate to improved methods, systems, devices, and apparatuses that support differential channel state information (CSI) reports. For example, the described techniques provide for configuring a user equipment (UE) to report a full CSI report and one or more partial CSI reports. In some examples, the UE may receive a message that indicates a CSI report configuration that identifies a quantity of CSI reports to be transmitted by the UE. The UE may generate, based on the CSI report configuration, a full CSI report and one or more partial CSI reports. The full CSI report may include at least a set of spatial domain basis functions and a set of channel coefficients associated with the set of spatial domain basis functions. The one or more partial CSI reports each include a respective set of differential channel coefficients. The UE may transmit the quantity of CSI reports. The quantity of CSI reports may include the full CSI report and the one or more partial CSI reports. Such techniques may therefore lead to reduced overhead associated with CSI reporting, among other possible benefits.

A method for wireless communication at a UE is described. The method may include receiving a message that indicates a CSI report configuration that identifies a quantity of CSI reports to be transmitted by the UE, generating, based on the CSI report configuration, a full CSI report and one or more partial CSI reports, where the full CSI report includes at least a set of spatial domain basis functions and a set of channel coefficients associated with the set of spatial domain basis functions, and where the one or more partial CSI reports each include a respective set of differential channel coefficients, and transmitting the quantity of CSI reports, where the quantity of CSI reports includes the full CSI report and the one or more partial CSI reports.

An apparatus for wireless communication is described. The apparatus may include a processor, memory coupled with the processor, and instructions stored in the memory. The instructions may be executable by the processor to cause the apparatus to receive a message that indicates a CSI report configuration that identifies a quantity of CSI reports to be transmitted by the UE, generate, based on the CSI report configuration, a full CSI report and one or more partial CSI reports, where the full CSI report includes at least a set of spatial domain basis functions and a set of channel coefficients associated with the set of spatial domain basis functions, and where the one or more partial CSI reports each include a respective set of differential channel coefficients, and transmit the quantity of CSI reports, where the quantity of CSI reports includes the full CSI report and the one or more partial CSI reports.

Another apparatus for wireless communication described. The apparatus may include means for receiving a message that indicates a CSI report configuration that identifies a quantity of CSI reports to be transmitted by the UE, means for generating, based on the CSI report configuration, a full CSI report and one or more partial CSI reports, where the full CSI report includes at least a set of spatial domain basis functions and a set of channel coefficients associated with the set of spatial domain basis functions, and where the one or more partial CSI reports each include a respective set of differential channel coefficients, and means for transmitting the quantity of CSI reports, where the quantity of CSI reports includes the full CSI report and the one or more partial CSI reports.

A non-transitory computer-readable medium storing code for wireless communication at a UE is described. The code may include instructions executable by a processor to receive a message that indicates a CSI report configuration that identifies a quantity of CSI reports to be transmitted by the UE, generate, based on the CSI report configuration, a full CSI report and one or more partial CSI reports, where the full CSI report includes at least a set of spatial domain basis functions and a set of channel coefficients associated with the set of spatial domain basis functions, and where the one or more partial CSI reports each include a respective set of differential channel coefficients, and transmit the quantity of CSI reports, where the quantity of CSI reports includes the full CSI report and the one or more partial CSI reports.

In some examples of the method, apparatuses, and non-transitory computer-readable medium described herein, generating the full CSI report and the one or more partial CSI reports may include operations, features, means, or instructions for receiving first signaling and second signaling over a channel for the wireless communication at the UE, the second signaling being received at the UE subsequent to the first signaling and generating the full CSI report based on the first signaling and a first partial CSI report of the one or more partial CSI reports based on the second signaling, where the full CSI report may be transmitted over a first time occasion and the first partial CSI report may be transmitted over a second time occasion subsequent to the first time occasion.

In some examples of the method, apparatuses, and non-transitory computer-readable medium described herein, the first partial CSI report includes a first set of differential channel coefficients and each differential channel coefficient of the first set of differential channel coefficients corresponds to a first channel coefficient difference relative to a respective channel coefficient of the set of channel coefficients.

In some examples of the method, apparatuses, and non-transitory computer-readable medium described herein, a number of bits used to represent each differential channel coefficient in the first partial CSI report having a non-zero value may be less than a number of bits used to represent respective channel coefficients in the full CSI report.

Some examples of the method, apparatuses, and non-transitory computer-readable medium described herein may further include operations, features, means, or instructions for receiving third signaling over the channel for the wireless communication at the UE, the third signaling being received at the UE subsequent to the second signaling, generating a second partial CSI report of the one or more partial CSI reports based on the third signaling, where the second partial CSI report includes a second set of differential channel coefficients and each differential channel coefficient of the second set of differential channel coefficients corresponds to a second channel coefficient difference relative to a respective differential channel coefficient of the first set of differential channel coefficients, and transmitting the second partial CSI report over a third time occasion subsequent to the second time occasion.

Some examples of the method, apparatuses, and non-transitory computer-readable medium described herein may further include operations, features, means, or instructions for receiving another message configuring the UE with a first one or more resources for transmitting the full CSI report over the first time occasion and a second one or more resources for transmitting the first partial CSI report over the second time occasion.

Some examples of the method, apparatuses, and non-transitory computer-readable medium described herein may further include operations, features, means, or instructions for receiving a first resource configuration indicating a first periodicity for transmitting a set of multiple full CSI reports, where the set of multiple full CSI reports includes the full CSI report, and where transmitting the full CSI report over the first time occasion may be based on the first resource configuration and receiving a second resource configuration indicating a second periodicity for transmitting the one or more partial CSI reports, where transmitting the first partial CSI report over the second time occasion may be based on the second resource configuration, and where a first length of the first periodicity may be different from a second length of the second periodicity.

In some examples of the method, apparatuses, and non-transitory computer-readable medium described herein, the CSI report configuration indicates a set of multiple resources for receiving the first signaling and the second signaling, the set of multiple resources may be periodic resources or semi-persistent resources, where receiving first signaling and second signaling further includes, and receiving the first signaling over a first one or more resources of the set of multiple resources and the second signaling over a second one or more resources of the set of multiple resources based on the CSI report configuration.

In some examples of the method, apparatuses, and non-transitory computer-readable medium described herein, the quantity of CSI reports includes a CSI report group and the quantity of CSI reports may be identified based on a CSI report group size indicated by the CSI report configuration.

In some examples of the method, apparatuses, and non-transitory computer-readable medium described herein, the CSI report configuration further indicates for each partial CSI report included in the CSI report group to be associated with the full CSI report or a preceding partial CSI report and generating the one or more partial CSI reports may be based on the CSI report configuration.

Some examples of the method, apparatuses, and non-transitory computer-readable medium described herein may further include operations, features, means, or instructions for receiving another message indicating a position of a CSI report of the CSI report group to be retransmitted by the UE, where the position corresponds to a first position associated with the full CSI report or a second position associated with a partial CSI report of the one or more partial CSI reports and retransmitting the full CSI report or the partial CSI report based on the position.

In some examples of the method, apparatuses, and non-transitory computer-readable medium described herein, generating the full CSI report and the one or more partial CSI reports may include operations, features, means, or instructions for receiving first signaling and second signaling over a channel for the wireless communication at the UE, the second signaling being received at the UE subsequent to the first signaling and generating the full CSI report based on the second signaling and a first partial CSI report of the one or more partial CSI reports based on the first signaling.

In some examples of the method, apparatuses, and non-transitory computer-readable medium described herein, transmitting the quantity of CSI reports may include operations, features, means, or instructions for transmitting the full CSI report and the first partial CSI report in a group report for the reference signal transmission group.

In some examples of the method, apparatuses, and non-transitory computer-readable medium described herein, the CSI report configuration includes an indication of the reference signal transmission group and the quantity of CSI reports may be identified based on a size of the reference signal transmission group.

Some examples of the method, apparatuses, and non-transitory computer-readable medium described herein may further include operations, features, means, or instructions for receiving third signaling over the channel for the wireless communication at the UE, the third signaling being received at the UE prior to the first signaling and the second signaling and generating a second partial CSI report of the one or more partial CSI reports based on the third signaling, where the full CSI report, the first partial CSI report, and the second partial CSI report may be transmitted in the group report for the reference signal transmission group, and where a number of bits included in the first partial CSI report may be greater than a number of bits included in the second partial CSI report.

In some examples of the method, apparatuses, and non-transitory computer-readable medium described herein, the full CSI report further includes a set of frequency domain basis functions and the set of channel coefficients includes a set of spatial frequency domain channel coefficients associated with the set of spatial domain basis functions and the set of frequency domain basis functions.

In some examples of the method, apparatuses, and non-transitory computer-readable medium described herein, a position of each differential channel coefficient of a set of differential channel coefficients corresponds to a same position or a different position as a respective spatial frequency domain channel coefficient of the set of spatial frequency domain channel coefficients.

A method for wireless communication at a network entity is described. The method may include outputting a message that indicates a CSI report configuration that identifies a quantity of CSI reports to be transmitted by a UE and obtaining the quantity of CSI reports, where the quantity of CSI reports includes a full CSI report that includes at least a set of spatial domain basis functions and a set of channel coefficients associated with the set of spatial domain basis functions and one or more partial CSI reports that each include a respective set of differential channel coefficients.

An apparatus for wireless communication is described. The apparatus may include a processor, memory coupled with the processor, and instructions stored in the memory. The instructions may be executable by the processor to cause the apparatus to output a message that indicates a CSI report configuration that identifies a quantity of CSI reports to be transmitted by a UE and obtain the quantity of CSI reports, where the quantity of CSI reports includes a full CSI report that includes at least a set of spatial domain basis functions and a set of channel coefficients associated with the set of spatial domain basis functions and one or more partial CSI reports that each include a respective set of differential channel coefficients.

Another apparatus for wireless communication is described. The apparatus may include means for outputting a message that indicates a CSI report configuration that identifies a quantity of CSI reports to be transmitted by a UE and means for obtaining the quantity of CSI reports, where the quantity of CSI reports includes a full CSI report that includes at least a set of spatial domain basis functions and a set of channel coefficients associated with the set of spatial domain basis functions and one or more partial CSI reports that each include a respective set of differential channel coefficients.

A non-transitory computer-readable medium storing code for wireless communication at a network entity is described. The code may include instructions executable by a processor to output a message that indicates a CSI report configuration that identifies a quantity of CSI reports to be transmitted by a UE and obtain the quantity of CSI reports, where the quantity of CSI reports includes a full CSI report that includes at least a set of spatial domain basis functions and a set of channel coefficients associated with the set of spatial domain basis functions and one or more partial CSI reports that each include a respective set of differential channel coefficients.

Some examples of the method, apparatuses, and non-transitory computer-readable medium described herein may further include operations, features, means, or instructions for outputting first signaling and second signaling over a channel for wireless communications with the UE, the second signaling being output subsequent to the first signaling, where the full CSI report may be based on the first signaling and a first partial CSI report of the one or more partial CSI reports may be based on the second signaling, and where the full CSI report may be obtained over a first time occasion and the first partial CSI report may be obtained over a second time occasion subsequent to the first time occasion.

In some examples of the method, apparatuses, and non-transitory computer-readable medium described herein, the first partial CSI report includes a first set of differential channel coefficients and each differential channel coefficient of the first set of differential channel coefficients corresponds to a first channel coefficient difference relative to a respective channel coefficient of the set of channel coefficients.

In some examples of the method, apparatuses, and non-transitory computer-readable medium described herein, a number of bits used to represent each differential channel coefficient in the first partial CSI report having a non-zero value may be less than a number of bits used to represent respective channel coefficients in the full CSI report.

Some examples of the method, apparatuses, and non-transitory computer-readable medium described herein may further include operations, features, means, or instructions for outputting third signaling over the channel for the wireless communications with the UE, the third signaling being output subsequent to the second signaling and obtaining a second partial CSI report of the one or more partial CSI reports based on the third signaling, where the second partial CSI report includes a second set of differential channel coefficients and each differential channel coefficient of the second set of differential channel coefficients corresponds to a second channel coefficient difference relative to a respective differential channel coefficient of the first set of differential channel coefficients, and where the second partial CSI report may be obtained over a third time occasion subsequent to the second time occasion.

Some examples of the method, apparatuses, and non-transitory computer-readable medium described herein may further include operations, features, means, or instructions for outputting another message configuring the UE with a first one or more resources for transmitting the full CSI report over the first time occasion and a second one or more resources for transmitting the first partial CSI report over the second time occasion.

Some examples of the method, apparatuses, and non-transitory computer-readable medium described herein may further include operations, features, means, or instructions for outputting a first resource configuration indicating a first periodicity for transmitting, by the UE, a set of multiple full CSI reports, where the set of multiple full CSI reports includes the full CSI report, and where obtaining the full CSI report over the first time occasion may be based on the first resource configuration and outputting a second resource configuration indicating a second periodicity for transmitting, by the UE, the one or more partial CSI reports, where obtaining the first partial CSI report over the second time occasion may be based on the second resource configuration, and where a first length of the first periodicity may be different from a second length of the second periodicity.

In some examples of the method, apparatuses, and non-transitory computer-readable medium described herein, the CSI report configuration indicates a set of multiple resources for receiving the first signaling and the second signaling, the set of multiple resources may be periodic resources or semi-persistent resources, where outputting first signaling and second signaling further includes, and outputting the first signaling over a first one or more resources of the set of multiple resources and the second signaling over a second one or more resources of the set of multiple resources based on the CSI report configuration.

In some examples of the method, apparatuses, and non-transitory computer-readable medium described herein, the quantity of CSI reports includes a CSI report group and the quantity of CSI reports may be identified based on a CSI report group size indicated by the CSI report configuration.

In some examples of the method, apparatuses, and non-transitory computer-readable medium described herein, the CSI report configuration further indicates for each partial CSI report included in the CSI report group to be associated with the full CSI report or a preceding partial CSI report and the one or more partial CSI reports may be based on the CSI report configuration.

Some examples of the method, apparatuses, and non-transitory computer-readable medium described herein may further include operations, features, means, or instructions for outputting another message indicating a position of a CSI report of the CSI report group to be retransmitted by the UE, where the position corresponds to a first position associated with the full CSI report or a second position associated with a partial CSI report of the one or more partial CSI reports and obtaining the full CSI report or the partial CSI report based on the position.

Some examples of the method, apparatuses, and non-transitory computer-readable medium described herein may further include operations, features, means, or instructions for outputting first signaling and second signaling over a channel for wireless communications with the UE, the second signaling being output subsequent to the first signaling, where the full CSI report may be based on the second signaling and a first partial CSI report of the one or more partial CSI reports may be based on the first signaling.

In some examples of the method, apparatuses, and non-transitory computer-readable medium described herein, obtaining the quantity of CSI reports may include operations, features, means, or instructions for obtaining the full CSI report and the first partial CSI report in a group report for the reference signal transmission group.

In some examples of the method, apparatuses, and non-transitory computer-readable medium described herein, the CSI report configuration includes an indication of the reference signal transmission group and the quantity of CSI reports may be identified based on a size of the reference signal transmission group.

Some examples of the method, apparatuses, and non-transitory computer-readable medium described herein may further include operations, features, means, or instructions for outputting third signaling over the channel for the wireless communications with the UE, the third signaling being output prior to the first signaling and the second signaling and obtaining a second partial CSI report of the one or more partial CSI reports based on the third signaling, where the full CSI report, the first partial CSI report, and the second partial CSI report may be obtained via the group report for the reference signal transmission group, and where the first partial CSI report includes a number of bits greater than the second partial CSI report.

In some examples of the method, apparatuses, and non-transitory computer-readable medium described herein, the full CSI report further includes a set of frequency domain basis functions and the set of channel coefficients includes a set of spatial frequency domain channel coefficients associated with the set of spatial domain basis functions and the set of frequency domain basis functions.

In some examples of the method, apparatuses, and non-transitory computer-readable medium described herein, a position of each differential channel coefficient of a set of differential channel coefficients corresponds to a same position or a different position as a respective spatial frequency domain channel coefficient of the set of spatial frequency domain channel coefficients.

### BRIEF DESCRIPTION OF THE DRAWINGS

FIGS. 1 and 2 each illustrate an example of a wireless communications system that supports differential channel state information (CSI) reports in accordance with one or more aspects of the present disclosure.

FIG. 3 illustrates an example of a process flow that supports differential CSI reports in accordance with one or more aspects of the present disclosure.

FIGS. 4 and 5 illustrates an example of a timing diagram that supports differential CSI reports in accordance with one or more aspects of the present disclosure.

FIG. 6 illustrates an example of a process flow that supports differential CSI reports in accordance with one or more aspects of the present disclosure.

FIG. 7 illustrates an example of a timing diagram that supports differential CSI reports in accordance with one or more aspects of the present disclosure.

FIG. 8 illustrates an example of a process flow that supports differential CSI reports in accordance with one or more aspects of the present disclosure.

FIGS. 9 and 10 show block diagrams of devices that support differential CSI reports in accordance with one or more aspects of the present disclosure.

FIG. 11 shows a block diagram of a communications manager that supports differential CSI reports in accordance with one or more aspects of the present disclosure.

FIG. 12 shows a diagram of a system including a device that supports differential CSI reports in accordance with one or more aspects of the present disclosure.

FIGS. 13 and 14 show block diagrams of devices that support differential CSI reports in accordance with one or more aspects of the present disclosure.

FIG. 15 shows a block diagram of a communications manager that supports differential CSI reports in accordance with one or more aspects of the present disclosure.

FIG. 16 shows a diagram of a system including a device that supports differential CSI reports in accordance with one or more aspects of the present disclosure.

FIGS. 17 through 22 show flowcharts illustrating methods that support differential CSI reports in accordance with one or more aspects of the present disclosure.

### DETAILED DESCRIPTION

A wireless multiple-access communications system may include one or more network entities, each simultaneously supporting communication for multiple communication devices, which may be otherwise known as user equipments (UEs). For example, a wireless communications system may be configured to support multi-input multi-output (MIMO) at various frequency bands to enable increased throughput within the communications system. In some examples, MIMO communication may be carried out via beamforming using multiple antennas at a transmitter (e.g., a network entity or a UE) and multiple antennas at a receiver (e.g., a network entity or a UE). In some examples, the UE and the network entity may share information regarding the quality of a communication channel to improve signal reliability and efficiency for MIMO communications. For example, a communications system may support a format for reporting channel state feedback in which a UE performs channel estimation and reports one or more parameters associated with the estimated communication channel to the network (e.g., one or more network entities). In some examples, the reported parameters may be referred to as channel state information (CSI) which may include a channel quality indicator (CQI), a precoding matrix indicator (PMI), or a rank indicator (RI), among other examples.

In some examples, precoding performed by the UE to transmit a signal may be determined by the network based on the CSI measured at the UE and reported to the network entity. For example, in response to receiving CSI from the UE, the network may indicate a precoder (e.g., a precoding matrix) to the UE to be used for precoding at the UE. In some examples, however, the UE may travel at relatively high speeds, such that the radio conditions experienced by the UE (e.g., the channel conditions) may change relatively quickly compared to a rate at which the network entity may obtain CSI from the UE. For example, a propagation delay associated with signaling an indication of the CSI to the network entity may be relatively long compared to the rate at which the channel conditions may change (e.g., due to the UE travelling at the relatively high speeds). As such, a precoder indicated to the UE by the network (e.g., based on the CSI reported to the network by the UE) may become outdated relatively quickly and degrade the performance of communications (e.g., uplink communications) between the UE and the network. Moreover, relatively frequent updating of the CSI (e.g., by the UE) may lead to increased overhead and reduced system throughput.

Various aspects of the present disclosure relate to techniques for a differential CSI reports and more specifically, to a configuring a UE to report a full CIS report and one or multiple partial CSI reports. For example, the network may transmit, to the UE, an indication of a CSI report configuration that identifies a quantity of CSI reports to be transmitted by the UE (e.g., to the network). In some examples, based on the CSI report configuration, the UE may transmit a full CSI report and one or more partial CSI reports to the network. The full CSI report may include one or more sets of basis functions (e.g., spatial domain basis functions, frequency domain basis functions) and a set of channel coefficients associated with the one or more sets of basis functions. Additionally, or alternatively, each partial CSI report may include a set of differential channel coefficients. In some examples, the UE may be configured to transmit the full CSI report based on (e.g., in response to) measurements performed on first signals (e.g., first reference signals) received by the UE and transmit one or more partial CSI reports based on (e.g., in response to) measurements performed on other reference signals received by the UE (e.g., subsequent to the first reference signals). In such examples, each differential channel coefficient of a set of differential channel coefficients included in a partial CSI report (e.g., each of the one or more partial CSI reports transmitted by the UE) may correspond to a channel coefficient difference relative to a respective channel coefficient included in the full CSI report or a previously transmitted CSI report (e.g., the full CSI report or another partial CSI report).

In some other examples, the UE may be configured to transmit a group report that may include a full CSI report and one or multiple partial CSI reports. In such examples, the network may transmit a set (e.g., a group) of reference signals to be measured by the UE for the group report. The full CSI report may be based on measurements performed by the UE on one or more relatively last (e.g., relatively recently) received reference signals (e.g., of the set of reference signals). Additionally, or alternatively, each partial CSI report may be based on measurements performed by the UE on other reference signals (e.g., of the set of reference signals) received by the UE prior to the relatively last received reference signals. In such an example, each differential channel coefficient included in a partial CSI report (e.g., each partial CSI reports included in the group report) may correspond to a channel coefficient difference relative to a respective channel coefficient of the set of channel coefficients included in the full CSI report.

Particular aspects of the subject matter described herein may be implemented to realize one or more of the following potential advantages. For example, the techniques employed by the described communication devices may provide benefits and enhancements to wireless communication devices operating within the network, including improved reliability of channel state feedback reporting within the wireless communication system. In some examples, operations performed by the described communication devices may provide improvements to techniques for CSI reporting and reduced signaling overhead within the wireless communications system. The operations performed by the described communication devices to improve techniques for CSI reporting may include configuring a communication device to transmit a full CSI report and one or more partial CSI reports. In some other implementations, operations performed by the described wireless communication devices may also support improvements to user experience and higher data rates, among other benefits.

Aspects of the disclosure are initially described in the context of wireless communications systems. Aspects of the disclosure are also described in the context of timing diagrams and process flows. Aspects of the disclosure are further illustrated by and described with reference to apparatus diagrams, system diagrams, and flowcharts that relate to differential CSI reports.

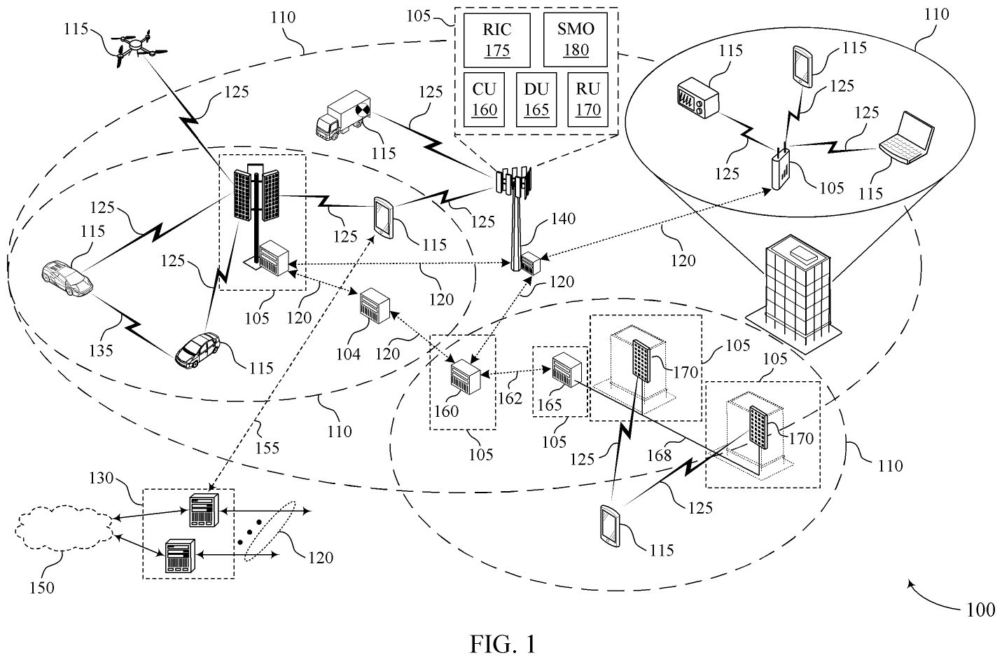

FIG. 1 illustrates an example of a wireless communications system 100 that supports differential CSI reports in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support differential CSI reports as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 200 may support one or more techniques for differential CSI reports. For example, a communication device, such as a UE 115, may receive a message (e.g., from one or more network entities) that indicates a CSI report configuration that identifies a quantity of CSI reports to be transmitted by the UE 115. The UE 115 may generate, based on the CSI report configuration, a full CSI report and one or more partial CSI reports. The full CSI report may include at least a set of spatial domain basis functions and a set of channel coefficients associated with the set of spatial domain basis functions. The one or more partial CSI reports each include a respective set of differential channel coefficients. The UE 115 may transmit the quantity of CSI reports (e.g., to the one or more network entities 105). The quantity of CSI reports may include the full CSI report and the one or more partial CSI reports. In some examples, by transmitting the quantity of CSI reports, the UE 115 may reduce overhead associated with CSI reporting and improve throughput within the wireless communications system 100, among other possible benefits.

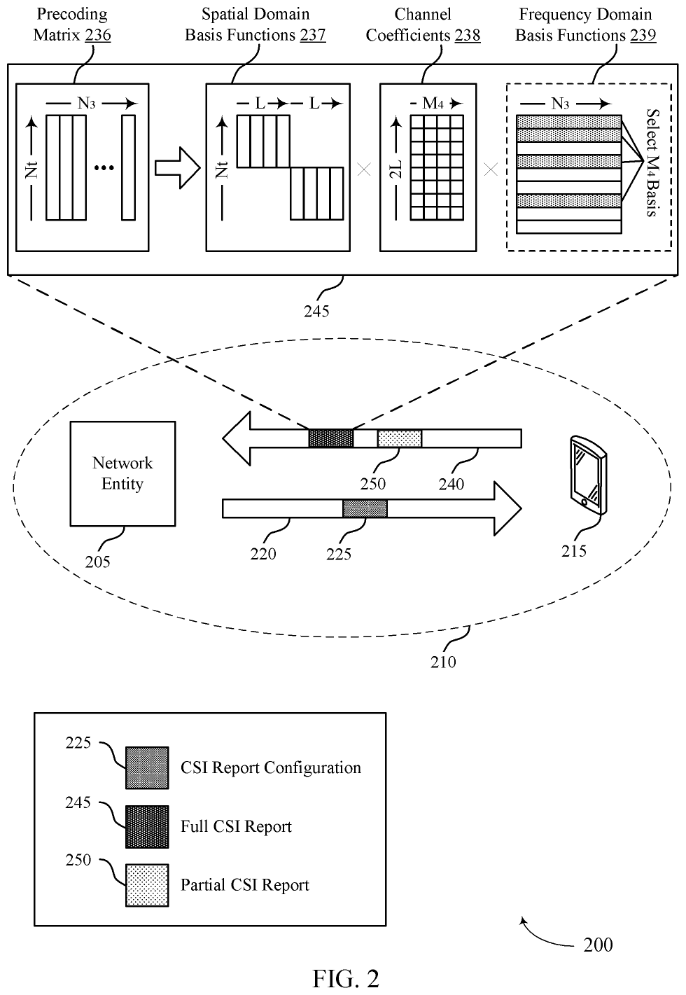

FIG. 2 illustrates an example of a wireless communications system 200 that supports differential CSI reports in accordance with one or more aspects of the present disclosure. In some examples, the wireless communications system 200 may implement or be implemented by one or more aspects of the wireless communications system 100. For example, the wireless communications system 200 may include a UE 215, which may be an example of a UE 115 described with reference to FIG. 1. The wireless communications system 200 may also include a network entity 205, which may be an example of one or more network entities 105 (e.g., a CU, a DU, an RU, a base station, an IAB node, or one or more other network nodes) as described with reference to FIG. 1. The network entity 205 and the UE 215 may communicate within a coverage areas 210, which may each be an example of a coverage area 110 as described with reference to FIG. 1. Additionally or alternatively the network entity 205 and the UE 215 may communicate over a downlink 220 and an uplink 240, which may each be examples of a communication link 125 described with reference to FIG. 1. The wireless communications system 200 may include features for improved communications between the network entity 205 and the UE 215, among other possible benefits.

The wireless communications system 200 may support MIMO communications to enable increased throughput within the wireless communications system 200. In some examples, to improve signal reliability and efficiency for MIMO communications, the network entity 205 and the UE 215 may share (e.g., exchange) information regarding the quality of a communication channel for the MIMO communications. For example, the UE 215 and the network entity 205 may support a format for reporting channel state feedback in which the UE 215 may perform channel estimation and report CSI associated with the estimated communication channel to the network (e.g., the network entity 205). In some examples, precoding performed by the UE 215 (e.g., to transmit a signal) may be determined by the network based on the reported CSI. For example, in response to receiving CSI from the UE 215, the network entity 205 may indicate a precoder (e.g., a precoding matrix) to the UE 215 to be used for precoding (e.g., for transmitting uplink communications) at the UE 215.

In some examples, however, the UE 215 may travel at relatively high speeds, such that channel conditions of the UE 215 may change relatively quickly compared to a rate at which the network entity 205 may obtain CSI from the UE 215 (e.g., due to a propagation delay associated with signaling an indication of the CSI to the network entity 205). As such, a precoder indicated to the UE 215 by the network (e.g., based on the reported CSI) may become outdated relatively quickly and degrade the performance of communications (e.g., uplink transmissions) at the UE 215. That is, some CSI reporting may not be suitable for relatively high or relatively medium Doppler scenarios (e.g., for scenarios in which the Doppler effect may have a relatively high or relatively medium impact on wireless communications between the UE 215 and the network entity 205, for a high time variant channel).

For example, if the UE 215 moves with a relatively low speed, a Doppler frequency value (e.g., a value of Doppler frequency shift in signals transmitted between the UE 215 and the network entity 205) may be relatively small, such that the channel response variance between multiple CSI reports (e.g., two CSI reports transmitted at different time instances) may be relatively small. Therefore, the reported CSI values (e.g., RI, PMI, and CQI) may be valid for an amount between the two CSI report (e.g., an amount of time between a first time instance over which a first CSI report is transmitted and a second time instance over which a second CSI report is transmitted). That is, the CSI values reported in the first CSI report (e.g., over the first time instance) may be valid for an amount of time prior to (e.g., until) a time instance of a subsequent (e.g., a next) CSI report (e.g., the second time instance over which the second CSI report is transmitted). However, if the UE 215 moves with relatively high speed, the value of the Doppler frequency shift (e.g., of signals transmitted between the UE 215 and the network entity 205) may be relatively large, such that the channel response variance between the two CSI reports may be relatively large. Thus, the reported CSI values (e.g., the RI, the PMI, the CQI) may not be valid until the time instance of a subsequent (e.g., the next) CSI report (e.g., may not be valid for the amount of time between the first CSI report and the second CSI report). Accordingly, use of such CSI values (e.g., obsolete CSI values) may lead to throughput of wireless communications between the UE 215 and the network entity 205 being degraded.

In some examples, the Doppler frequency shift (e.g., a Doppler-shifted frequency, a Doppler frequency) of a signal transmitted between the network entity 205 and the UE 215 may be described in accordance with Equation 1:

$${f}_{d} = \frac{{f}_{c} \cdot {v}_{U E} cos θ}{{v}_{l i g h t}} \qquad ( 1 )$$

in which f_{d} may represent the Doppler frequency, f_{c} may represent a carrier frequency of the signal, v_{UE} may represent a speed of the UE 215, v_{light} may represent light speed (e.g., the speed of light), and θ may represent an angle between an arrival direction of the transmitted signal (e.g., the radio wave) and the direction at which the UE 215 may be moving.

In some examples, signals transmitted between the UE 215 and the network entity 205 may experience multipath propagation, such that the transmitted signals may reach a receiving communication device (e.g., the UE 215 or the network entity 205) by multiple (e.g., more than two) paths. Multipath propagation may result from atmospheric ducting, refraction, or reflection off of objects in the surrounding area. In some examples, multipath propagation may result in interference and phase shifting of the transmitted signals (e.g., multipath interference or multipath distortion), which may affect the signals prior to detection at a receiving communication device (e.g., the UE 215 or the network entity 205). That is, a signal at the time it is received may be altered relative to the signal at the time it is transmitted. In some examples, a response of a communication channel (e.g., a channel response) may refer to an impulse response function of the communication channel. That is, the channel may be characterized by a channel transfer function or a time domain Fourier transform of the impulse response function of the communication channel. In some examples, impulse response function may refer to a reaction (e.g., output) of a system in response to an external change (e.g., input). As such, the impulse response function may account for different impulses of the transmitted signal (e.g., brief input signals) arriving at the receiving device (e.g., the UE 215 or the network entity 205) at different times (e.g., due to experiencing different paths). That is, the impulse response function of the communication channel may describe the behavior of the system (e.g., the communication channel) as a function of time. Thus, knowledge of the impulse response function (e.g., the reported CSI) of the communication channel (e.g., the response of the communication channel or channel response) may aid the network in determining a suitable precoder for the UE 215.

For wideband MIMO communications (e.g., for a wideband channel model) the channel response (e.g., a channel matrix representing the channel) at a time instance (n) and for a subcarrier (k) may be represented in accordance with Equation 2:

$$H ( n , k ) = {\sum }_{l = 0}^{L} {a}_{l} {u}_{l} {v}_{l}^{H} {e}^{\frac{j 2 π {τ}_{l} k}{N}} {e}^{j 2 π {f}_{d , l} {t}_{n}} \qquad ( 2 )$$

in which H (n,k) may represent the channel response, uₗ may represent a steering vector related to an angle of arrival (e.g., of the signal), vₗ^{H} may represent a steering vector related to an angle of departure (e.g., of the signal), τₗ may represent a delay associated with the signal (e.g., a propagation delay), and f_{d,l} may represent the Doppler frequency for a path (l).

In some examples, such as for a uniform linear array (ULA) antenna panel or a uniform planar array (UPA) antenna panel, the steering vectors may be discrete Fourier transform (DFT) vectors. In some examples, because different paths may have different arrival directions, values of the Doppler frequency (f_{d,t}) may be different (e.g., for different paths). As such, a combined result (e.g., a combination result) of multiple (e.g., different) paths may vary over a duration (e.g., with time). In some examples, increased Doppler frequency values (e.g., due to increased speeds of the UE, increased values of the parameter v_{UE}), may lead to an increased rate of (e.g., faster) variance in the channel response (H (n,k). Therefore, if the UE 215 is moving relatively fast, the Doppler effect may lead to a relatively high time variant channel status. For example, if an update of the channel status determined by the network entity 205 (e.g., owned at the network entity 205, owned at a gNB) is delayed relative to the channel time variance (e.g., relative to variations in the channel over time), the precoder (e.g., the precoding matrix) indicated to the UE 215 (e.g., based on the update of the channel status determined by the network entity 205) may become invalid (e.g., obsolete) and lead to transmission failures at the UE 215. In other words, obsolete CSI may be invalid in relatively high-speed MIMO scenarios. For example, the UE 215 may be configured to perform codebook based precoding (e.g., using a Type II CSI codebook). In such an example, if CSI is reported (e.g., by the UE 215) over a relatively long duration (e.g., with a periodicity of about 10 slots), a relatively latest (e.g., a relatively last, a relatively recent) reported PMI may be increasingly unmatched with the channel status (e.g., the current channel status) as time elapses, thereby degrading the throughput. Additionally, or alternatively, if CSI is reported over a relatively short duration (e.g., with a periodicity of about one slot), the uplink signaling overhead may be relatively high and lead to reduced downlink throughput.

In some examples, to reduce the likelihood of transmission failures, one or more CSI reporting techniques may be employed by the UE 215 and the network entity 205. For example, the UE 215 may report CSI with a relatively long time interval (e.g., approximately 20 ms) and each CSI report (e.g., transmitted by the UE 215 over the relatively long time interval) may include a full CSI report and prediction information associated with the channel (e.g., of channel matrix) or the precoding matrix (e.g., precoder). While such techniques may lead to reduced CSI report overhead (e.g., reduce uplink resource consumption), a CSI codebook (e.g., a spatial-frequency-time codebook, a 3 dimensional (3D) codebook) suitable for such techniques may increase UE complexity (e.g., increase processing complexity at the UE 215). Additionally or alternatively, the UE 215 may report CSI with a relatively short time interval (e.g., approximately 2 ms) and each CSI report (e.g., transmitted by the UE 215 over the relatively short time interval) may include a full CSI report. While such techniques may reduce complexity at the UE 215, relatively frequent updating of the CSI (e.g., by the UE) may lead to relatively high CSI report overhead (e.g., increased uplink resource consumption).

In some examples, techniques for differential CSI reporting for a high time variant channel, as described herein, may provide one or more enhancements to CSI reporting in the wireless communications system 200. For example, such techniques may provide one or more enhancements for relatively high or relatively medium UE velocities by exploiting time-domain correlation and Doppler-domain information, for example to assist precoding (e.g., downlink precoding or uplink precoding) for one or more frequency ranges (e.g., FR1, FR2). In some examples, such techniques may provide one or more refinements to codebooks, such as Type-II codebooks (e.g., without modification to spatial domain and frequency domain basis functions). Additionally, or alternatively, such techniques may enable UE reporting of time-domain channel properties, for example measured via reference signals (e.g., CSI-RSs) for tracking.

Techniques for differential CSI reporting (e.g., for Type II codebooks or enhanced Type II codebooks), as described here, may provide one or more enhancements to CSI reporting techniques, such as CSI reporting techniques in which a full CSI report and prediction information is transmitted over a relatively long time interval or a full CSI report is transmitted over a relatively short time interval. For example, in accordance with some techniques for a differential CSI report, the UE 215 may report CSI with a relatively short time interval (e.g., approximately 2 ms) and each CSI report may include partial (e.g., differential) CSI. In some examples, such techniques may lead to reduced CSI report overhead (e.g., reduced uplink resource consumption) and reduced UE complexity. In some examples, such techniques may include retransmissions of CSI reports and signaling (e.g., signaling messages) for one or more codebooks (e.g., Type II codebooks or enhanced Type II codebooks).

As illustrated in the example of FIG. 2, the UE 215 may receive a message that indicates a CSI report configuration 225 that identifies a quantity of CSI reports to be transmitted by the UE 215. The UE 215 may generate a full CSI report 245 and one or more partial CSI reports 250 based on the CSI report configuration 225. In some examples, the full CSI report 245 may indicate a precoding matrix 236. For example, the full CSI report 245 may include a set of spatial domain basis functions 237 and a set of channel coefficients 238. In such an example, the set of channel coefficients 238 may be associated with the set of spatial domain basis functions 237. For example, the set of channel coefficients 238 may be spatial domain channel coefficients. In some other examples, the full CSI report 245 may include the set of spatial domain basis functions 237, the set of channel coefficients 238, and a set of frequency domain basis functions 239. In such examples, the set of channel coefficients 238 may be associated with the set of spatial domain basis functions 237 and the set of frequency domain basis functions 239. For example, the set of channel coefficients 238 may be spatial frequency domain channel coefficients. Additionally, or alternatively, the one or more partial CSI reports 250 may each include a respective set of differential channel coefficients.

For one transmit layer, the precoding matrix 236 (e.g., a compressed Type II precoder (W)) may exploit a sparsity of both the spatial domain and the frequency domain. For example, the precoding matrix 236 may be described in accordance with Equation 3:

$$W = {W}_{1} \tilde{{W}_{2}} {W}_{f}^{H} \qquad ( 3 )$$

in which W may represent the precoding matrix 236, W₁ may represent the set of spatial domain basis functions 237, \tilde{W}₂ may represent the set of channel coefficients 238 (e.g., spatial frequency domain channel coefficients), and W_{f}^{H} may represent the set of frequency domain basis functions 239. In some examples, the precoding matrix 236 (e.g., represented by the matrix W) may include a quantity of rows (Nₜ) that may be described in accordance with Equation 4:

$${N}_{t} = 2 {N}_{1} {N}_{2} \qquad ( 4 )$$

in which N₁ may represent the spatial domain, and N₂ may represent a quantity of ports (e.g., antenna ports at the UE 215). Additionally, or alternatively, precoding matrix 236 may include a quantity of columns (N₃) that may each represent a frequency-domain compression unit (e.g., including resource blocks or reporting sub-bands).

In some examples, the spatial domain basis functions 237 (e.g., represented by the matrix W₁) may include spatial basis functions that account for (e.g., include, consider) a quantity of beams (L). For example, the spatial domain basis functions 237 may include a quantity of columns (L) per polarization group (e.g., about 2L beams). Additionally, or alternatively, the set of channel coefficients 238 (e.g., represented by the matrix \tilde{W}₂) may include a linear combination of coefficients (e.g., amplitude and co-phasing coefficients), in which each element (e.g., of the matrix \tilde{W}₂) may represent the coefficient of a tap for a beam. For example, (e.g., for a Type II precoding matrix composition for one layer), in the matrix \tilde{W}₂ one row may correspond to one spatial beam and in the matrix W₁ one entry may represent the coefficient of one tap for the spatial beam.

Additionally or alternatively, an entry in the matrix \tilde{W}₂ may correspond to a row of the matrix W_{f}^{H} (or a column of a basis vector matrix (W_{f})). For example, the set of frequency domain basis functions 239 (e.g., represented by the matrix W_{f}^{H}) may include basis vectors (e.g., each row of the matrix W_{f}^{H} may be a basis vector) used to perform compression in the frequency domain. In some examples, the basis vectors included in the matrix W_{f} may be derived from a quantity of columns in a discrete Fourier transform matrix. In some examples, the precoding matrix 236 (e.g., a Type II precoder matrix) for multiple layers (e.g., for three layers, for three transmit layers, for three sub-bands) may be described in accordance with Equation 5:

$$\{ \begin{matrix}{W}^{( 1 )} = {W}_{1} {\tilde{W}}_{2}^{1} {W}_{f}^{( 1 ) , H} \\ {W}^{( 2 )} = {W}_{1} {\tilde{W}}_{2}^{2} {W}_{f}^{( 2 ) , H} \\ {W}^{( 3 )} = {W}_{1} {\tilde{W}}_{2}^{3} {W}_{f}^{( 3 ) , H}\end{matrix} \qquad ( 5 )$$

in which W⁽ⁿ⁾ may represent the precoding matrix 236 for the nth layer.

In some examples, the set of spatial frequency coefficients (e.g., represented by the matrix \tilde{W}₂ⁿ) may include a quantity of elements (e.g., 2L×N₃ elements). For example (e.g., for each (l) layer), the UE 215 may report up to a quantity of coefficients (K₀), such as K₀ non-zero coefficients. In some examples, the quantity of coefficients (K₀) may be configured by the network (e.g., via RRC signaling). In some examples (e.g., across all layers), the UE 215 may report another quantity of coefficients (2K₀), such as 2K₀ non-zero coefficients. Additionally, or alternatively, unreported coefficients may be set to zero. In some examples, the UE 215 may report a coefficient selection for a quantity of layers, such as via a rank indicator (RI). For example, the UE 215 may report a coefficient selection for layer 0 through layer RI-1. Additionally, or alternatively, the UE 215 may report a number of quantization bits used to indicate the amplitude and the phase for each non-zero coefficient (e.g., for each spatial frequency coefficient).

In some examples, the set of spatial frequency coefficients (\tilde{W}₂ⁿ) may be quantized and reported, such that the positions of the non-zero coefficients included in a set of differential channel coefficients (Δ\tilde{W}₂ⁿ) of a partial CSI report may be the same as the positions of the non-zero coefficients included the set of channel coefficients (\tilde{W}₂ⁿ) of the full CSI report. Thus, the UE 215 may report the quantization bits of the amplitude and the phase for each non-zero element. In some examples, the quantization bits may be configured by the network (e.g., via RRC signaling). Additionally, or alternatively, the set of spatial frequency coefficients (\tilde{W}₂ⁿ) may be quantized and reported, such that the positions of the non-zero coefficients included in a set of differential channel coefficients (Δ\tilde{W}₂ⁿ) of a partial CSI report may be different from the positions of the non-zero coefficients included the set of channel coefficients (\tilde{W}₂ⁿ) of the full CSI report. Thus, the UE 215 may report a coefficient selection and the quantization bits for each non-zero element. In some examples, the UE 215 may report the coefficient selection expressed by a bit map, such as an RI×2 LM bitmap. In some examples, the network may indicate to the UE 215 (e.g., through a configuration indicated via RRC signaling) whether a position of each differential channel coefficient of a set of differential channel coefficients corresponds to a same position or a different position as a respective spatial frequency domain channel coefficient of the set of spatial frequency domain channel coefficients.

In some examples, the UE 215 may transmit the quantity of CSI reports identified by the CSI report configuration 225 (e.g., the full CSI report 245 and the one or more partial CSI reports 250) to the network entity 205. In some examples, by transmitting the one or more partial CSI reports 250, the UE 215 may reduce signaling overhead within the wireless communications system 200, among other possible benefits.

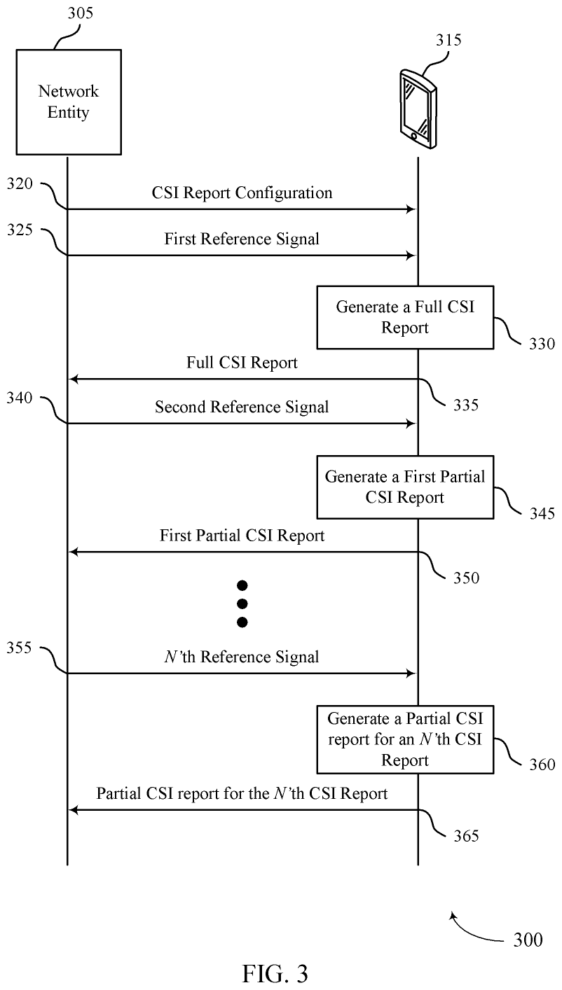

FIG. 3 illustrates an example of a process flow 300 that supports differential CSI reports in accordance with one or more aspects of the present disclosure. In some examples, the process flow 300 may implement or be implemented by one or more aspects of the wireless communications systems 100 and 200. For example, the process flow 300 may be implemented by a network entity 305 and a UE 315, which may be examples of the corresponding devices described with reference to FIGS. 1 and 2. In the following description of the process flow 300, the operations between the UE 315 and the network entity 305 may be performed in different orders or at different times. Some operations may also be omitted.

A wireless communications system may support one or more designs for signaling messages communication devices (e.g., the UE 315 and the network entity 305) to support one or more functions of differential CSI reporting (e.g., based on Type II codebooks and enhanced Type II codebooks). In some examples, differential CSI reporting may include distributed differential CSI reporting, in which a quantity of CSI reports (e.g., based on multiple reference signals, multiple CSI-RS, multiple TRS) may be transmitted over multiple occasions (e.g., may be transmitted in different slots). Additionally, or alternatively, differential CSI reporting may include concentrated differential CSI reporting, in which the quantity of CSI reports (e.g., based on multiple reference signals, multiple CSI-RS, multiple TRS) may be transmitted over a single occasion (e.g., may be transmitted in one slot). Such techniques for differential CSI reporting (e.g., the distributed differential CSI reporting and the concentrated differential CSI reporting) may be used for one or more types of codebooks (e.g., Type II codebooks, type II port selection codebooks, enhanced type II codebooks, and enhanced type II port selection codebooks). Additionally, or alternatively, such techniques for differential CSI reporting may include a framework for handling of CSI reports that may not be transmitted or that may not be received by the network (e.g., missing CSI reports).

For differential CSI reporting, as illustrated in the example of FIG. 3, the network may configure the UE 315 with a quantity of CSI reports that may be grouped. For example, at 320, the network entity 305 may transmit a CSI report configuration (e.g., a CSI report configuration message, a message indicating a CSI report configuration) that may indicate a quantity of (N_{csi}) CSI reports (e.g., at different time occasions) that may be grouped. That is, in the CSI report configuration message transmitted at 320), the network entity 305 (e.g., a gNB) may include one or more parameters that may indicate a size of CSI report group (e.g., denoted as N_{csi}). Additionally, or alternatively, the network entity 305 may include one or more other parameters, such a parameter that indicate resources over which reference signals (e.g., CSI-RS or TRS) may be transmitted to the UE for generating the quantity of CSI reports and a parameter indicating whether the partial CSI reports are associated with the full CSI report or a prior CSI report. In some examples, the indicated resources may be periodic or semi-persistent.

In such an example, at the time occasion of a first CSI report (e.g., of the quantity of CSI reports indicated by the CSI report configuration transmitted at 320), the UE 315 may report a full CSI (e.g., based on a Type II codebook or an enhanced Type II codebook). For example, at 325, the UE 315 may receive a first reference signal (e.g., a first CSI-RS or a first TRS) from the network entity 305. At 330, the UE 315 may generate a full CSI report (e.g., based on one or more measurements performed by the UE 315 on the first reference signal). At 335 (e.g., at the first time occasion of the first CSI report), the UE 315 may transmit the full CSI report to the network entity 305. The full CSI report may be an example of a full CSI report as described with reference to FIG. 2. For example, the full CSI report may include at least a set of spatial domain basis functions and a set of channel coefficients. In some examples, the full CSI report may include the set of spatial domain basis functions, the set of channel coefficients, and a set of frequency domain basis functions.

At one or more other time occasions (e.g., one or more time occasions for transmitting one or more other CSI report, the UE 315 may report a partial CSI (e.g., based on a Type II codebook or an enhanced Type II codebook). For example, at 340, the UE 315 may receive a second reference signal (e.g., a second CSI-RS or a second TRS) from the network entity 305. At 345, the UE 315 may generate a first partial CSI report (e.g., based on one or more measurements performed by the UE 315 on the second reference signal). At 350 (e.g., at a time occasion of another CSI report), the UE 315 may transmit the first partial CSI report to the network entity 305. In some examples, a quantity of partial CSI reports transmitted by the UE 315 may depend on the quantity of CSI reports indicated by the CSI report configuration (e.g., transmitted to the to the UE 315 at 320). For example, the network may indicate (e.g., via N_{csi}) for N CSI reports to be transmitted by the UE 315 and may transmit N reference signals to the UE 315 for generating the N CSI report, in which one of the N CSI reports may include the full CSI report and N-1 CSI reports may include the one or more partial CSI reports. For example, at 355, the UE 315 may receive an Nth reference signal (e.g., an Nth CSI-RS or an Nth TRS) from the network entity 305. At 360, the UE 315 may generate a partial CSI report for an Nth CSI report (e.g., based on one or more measurements performed by the UE 315 on the Nth reference signal). That is, the UE 315 may generate an Nth CSI report that may include a partial CSI report (e.g., the (N-1)th partial CSI report). At 365, the UE 315 may transmit the partial CSI report for the Nth CSI report to the network entity 305. That is, the UE 315 may transmit the Nth CSI report which may be a partial CSI report (e.g., the N-1th partial CSI report).

In some examples, the one or more partial CSI reports may be associated with the channel time variance of spatial channel coefficients or spatial-frequency channel coefficients compared with previous CSI reports in the group (e.g., the quantity of CSI reports). For example, each partial CSI report may include a respective set of differential channel coefficients. In some examples, each set of differential channel coefficients (e.g., included in the one or more partial CSI reports) may be associated with the first CSI report of this group. Additionally, or alternatively, each set of differential channel coefficients (e.g., included in the one or more partial CSI reports) may be associated with another CSI report of the group (e.g., the full CSI report or a previously transmitted partial CSI report). In some examples, the UE 315 may determine whether the partial CSI reports are to be based on (e.g., related to) the first CSI report or a prior CSI report based on the CSI report configuration. For example, the CSI report configuration may indicate a selection of a first option that may indicate for each partial CSI Report to be related to (e.g., to include differential channel coefficients associated with) the first CSI report or the selection of a second option that may indicate for each partial CSI report include differential channel coefficients associated with a prior CSI report.

In some examples, if the network entity 305 (e.g., the gNB) misses a portion of the CSI reports in the CSI report group (e.g., fails to receive the portion of the CSI reports, fails to decode the portion of the CSI reports, experiences a decoding failure), the UE may resend (e.g., retransmit) the missed portion. For example, if the network entity fails to receive or fails to decode the first CSI report (e.g., the full CSI report transmitted at 335) or an intermediate CSI report in a CSI report group (e.g., one or more partial CSI reports transmitted subsequent to the first CSI report), the UE may retransmit the one or more missed reports. In some examples, the network may configure the UE to retransmit the one or more missed reports by indicating a position of the missed CSI report in the CSI report group. For example, each CSI report may be associated with an identifier (e.g., index) based on the position of the report within the CSI report group. The network may configure one or more aperiodic uplink resources (e.g., one or more PUSCH resources) for the UE 315 to retransmit the indicated CSI report (e.g., the missed CSI report).

In some examples, if the network fails to receive (or fails to decode) a CSI report of the CSI report group, the UE 315 may be configured to restore the first CSI report in the CSI report group. For example, the UE 315 may be configured to restore the full CSI report via RRC signaling, a MAC-CE, or a DCI. Additionally, or alternatively, the UE 315 may be configured to restore all CSI reports in the CSI report group. In some examples, the UE 315 may be configured to restore all CSI reports of a CSI group via RRC signaling, a MAC CE, or a DCI. In some examples, the network may configure the UE 315 to restore all of the CSI Reports of the CSI group by adding a field in a DCI, such as a CSI report position field, or by modifying a field in a DCI (e.g., a DCI format 0_0, a DCI format 0_1, or a DCI format 0_2). Additionally, or alternatively, in some examples, if the one or more aperiodic uplink resources (e.g., the one or more PUSCH resources) for CSI reporting is in a same slot as an occasion of a periodic or semi-persistent uplink resource (e.g., a PUCCH resource or another PUSCH resource) for CSI reporting, the first transmission and one or more retransmissions of the CSI report (e.g., one or more missed CSI reports) may be transmitted the aperiodic uplink resource. In some examples, by transmitting distributed differential CSI reports, the UE 315 may reduce signaling overhead within the wireless communications system 200, among other possible benefits.

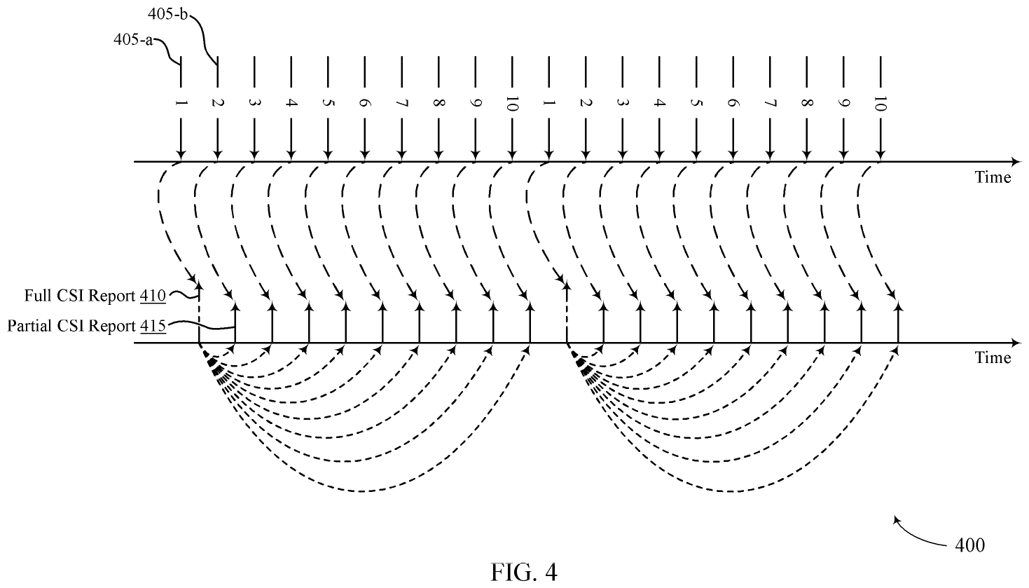

FIG. 4 illustrates an example of a timing diagram 400 that supports differential CSI reports in accordance with one or more aspects of the present disclosure. In some examples, the timing diagram 400 may implement or be implemented by one or more aspects of the wireless communications systems 100 and 200. For example, the timing diagram 400 may be implemented by a network entity and a UE, which may be examples of the corresponding devices described with reference to FIGS. 1 and 2.

Some wireless communications systems may support distributed differential CSI reporting, in which a communication device (e.g., a UE) may transmit a quantity of (N) CSI reports (e.g., a CSI report group) to the network over multiple occasions (e.g., in different slots). In some examples, the UE may transmit a group of CSI reports (e.g., N CSI reports) that may include a full CSI report 410 and one or more (e.g., N-1) partial CSI report 415. For example, during a CSI report group, the radio channel parameters (e.g., an angle of departure, an angle of arrival, a zenith of departure, a zenith of arrival, and a delay) may experience relatively little changes. As such, the UE may transmit the full CSI report 410 that may include spatial domain channel coefficients or spatial frequency domain channel coefficients. Additionally, or alternatively, the UE may transmit one or more partial CSI reports 415 that may include one or more updates of the spatial domain channel coefficients or the spatial frequency domain channel coefficients. For example, each of the one or more partial CSI reports 415 may include a set of differential channel coefficients that may indicate updates of the spatial domain channel coefficients or the spatial frequency domain channel coefficients (e.g., included in the full CSI report 410).

In some examples of distributed differential CSI reporting, each set of differential channel coefficients (e.g., included in the one or more partial CSI reports 415) may be associated with a first CSI report of the CSI report group (e.g., the full CSI report 410). For example, as illustrated in the example of FIG. 4, the network may transmit a quantity of reference signals (e.g., one or more reference signals 405 indexed from 1 to 10) to be used by the UE for the distributed differential CSI report. In some examples, based on the CSI report configuration, the UE may generate a first CSI report (e.g., of the CSI report group) that may be a full CSI report and may be based on one or more measurements performed by the UE on a reference signal 405-a (e.g., a CSI-RS or a TRS). The reference signal 405-a may be a relatively first received reference signal of a group of reference signals received by the UE for the CSI report group (e.g., a group of reference signals 405 indexed from 1 to 10). The UE may transmit the full CSI report (e.g., the first CSI report of the CSI report group) to the network over a first time occasion. Additionally, or alternatively, based on the CSI report configuration, the UE may generate a second CSI report that may be a partial CSI report based on one or more measurements performed by the UE on a reference signal 405-b (e.g., another CSI-RS or another TRS). The reference signal 405-b may be received by the UE subsequent to the relatively first received reference signal (e.g., of the group of reference signals received by the UE for the CSI report group). The UE may transmit the partial CSI report (e.g., the second CSI report of the CSI report group) to the network over a second time occasion.

In some examples, uplink resource to send the differential CSI may be configured by the network. For example, the network (e.g., a gNB) may configure aperiodic or semi-persistent PUSCH resource for each CSI report. That is, one or more PUSCH resources corresponding to the first occasion and one or more PUSCH resources corresponding to the second occasion may be configured by the network periodically or semi-persistently.

In some examples, the UE may support distributed differential CSI reporting for one or more types of codebooks. For example, the UE may support distributed differential CSI reporting for Type II codebooks, Type II port selection codebooks, enhanced type II codebooks, and enhanced type II port selection codebooks. For Type II codebooks and Type II port selection codebooks, the UE may be configured to transmit a full CSI report that may include a set of spatial domain basis functions and a set of channel coefficients. In such an example, the set of channel coefficients may be associated with the set of spatial domain basis functions. For example, the set of channel coefficients included in the full CSI report may correspond to the spatial domain coefficients. Additionally, or alternatively, for Type II codebooks and Type II port selection codebooks, an nth partial CSI report may include (e.g., for each transmit layer (l)) a set of differential channel coefficients (ΔW₂⁽ⁿ⁾) that may be determined in accordance with Equation 6:

$$Δ {W}_{2}^{( n )} = {W}_{2}^{( n )} - {W}_{2}^{( 1 )} \qquad ( 6 )$$

in which each differential channel coefficient of the set of differential channel coefficients (ΔW₂⁽ⁿ⁾) included in the nth partial CSI report may corresponds to a channel coefficient difference relative to a respective channel coefficient of the set of channel coefficients included in the full CSI report.

For enhanced type II codebooks and enhanced type II port selection codebooks, the UE may be configured to transmit a full CSI report that may include the set of spatial domain basis functions, the set of channel coefficients, and a set of frequency domain basis functions. In such examples, the set of channel coefficients may be associated with the set of spatial domain basis functions and the set of frequency domain basis functions. For example, the set of channel coefficients included in the full CSI report may correspond the spatial frequency domain coefficients. Additionally, or alternatively, for enhanced type II codebooks and enhanced type II port selection codebooks, an nth partial CSI report may include (e.g., for each (l) transmit layer) a set of differential channel coefficients (Δ\tilde{W}₂⁽ⁿ⁾) that may be determined in accordance with Equation 7:

$$Δ {\tilde{W}}_{2}^{( n )} = {\tilde{W}}_{2}^{( n )} - {\tilde{W}}_{2}^{( 1 )} \qquad ( 7 )$$

in which each differential channel coefficient of the set of differential channel coefficients (Δ\tilde{W}₂⁽ⁿ⁾) included in the nth partial CSI report may corresponds to a channel coefficient difference relative to a respective channel coefficient of the set of channel coefficients included in the full CSI report.

In some examples, partial CSI reports that include differential channel coefficients that corresponds to a channel coefficient difference relative to a respective channel coefficient of the set of channel coefficients (e.g., included in the full CSI) may have a reduced quantity of quantization bits included in the partial CSI report. For example, an amplitude and phase of each non-zero element (e.g., each differential channel coefficient) included in the set of differential channel coefficients (Δ\tilde{W}₂ⁿ) may be quantized with relatively less bits than the set of channel coefficients (W₂⁽ⁿ⁾) included in the full CSI report. Additionally or alternatively, an amplitude and phase of each non-zero element (e.g., each differential channel coefficient) included in the set of differential channel coefficients (Δ\tilde{W}₂⁽ⁿ⁾) may be quantized with relatively less bits than the set of channel coefficients (\tilde{W}₂⁽ⁿ⁾) included in the full CSI report.

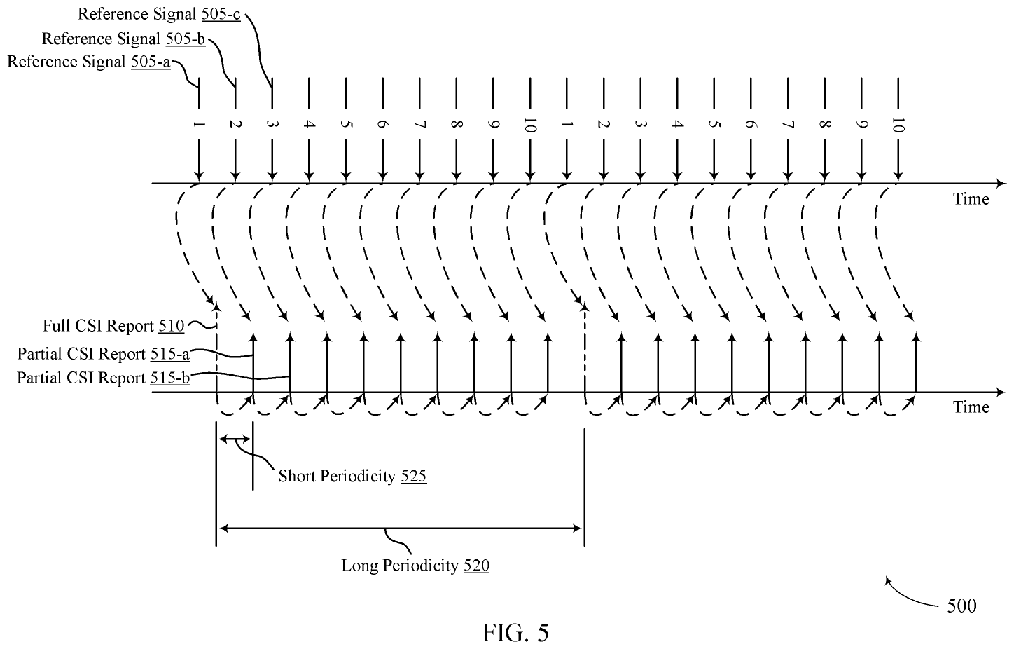

FIG. 5 illustrates an example of a timing diagram 500 that supports differential CSI reports in accordance with one or more aspects of the present disclosure. In some examples, the timing diagram 500 may implement or be implemented by one or more aspects of the wireless communications systems 100 and 200. For example, the timing diagram 500 may be implemented by a network entity and a UE, which may be examples of the corresponding devices described with reference to FIGS. 1 and 2.

In some examples of distributed differential CSI reporting, each set of differential channel coefficients (e.g., included in one or more partial CSI reports 515) may be associated with another CSI report of the CSI report group (e.g., a full CSI report 510 or a previously transmitted partial CSI report 515). For example, as illustrated in the example of FIG. 5, the network may transmit a quantity of reference signals (e.g., one or more reference signals 505 indexed from 1 to 10) to be used by the UE for the distributed differential CSI report. In some examples, based on the CSI report configuration, the UE may generate a first CSI report (e.g., of the CSI report group) that may be the full CSI report 510 and may be based on one or more measurements performed by the UE on a reference signal 505-a (e.g., a CSI-RS or a TRS). The reference signal 505-a may be a relatively first received reference signal of a group of reference signals received by the UE for the CSI report group. The UE may transmit the full CSI report 510 (e.g., the first CSI report of the CSI report group) to the network over a first time occasion. Additionally, or alternatively, based on the CSI report configuration, the UE may generate a second CSI report that may be a first partial CSI report (e.g., a partial CSI report 515-a) based on one or more measurements performed by the UE on a reference signal 505-b (e.g., another CSI-RS or another TRS). The reference signal 505-b may be received by the UE subsequent to the reference signal 505-a. The UE may transmit the partial CSI report 515-a (e.g., the second CSI report of the CSI report group, the first partial CSI report) to the network over a second time occasion (e.g., subsequent to the first time occasion). Additionally, or alternatively, based on the CSI report configuration, the UE may generate a third CSI report that may be a second partial CSI report (e.g., a partial CSI report 515-b) based on one or more measurements performed by the UE on a reference signal 505-c (e.g., another CSI-RS or another TRS). The reference signal 505-c may be a received by the UE subsequent to the reference signal 505-b. The UE may transmit the partial CSI report 515-b (e.g., the third CSI report of the CSI report group, the second partial CSI report) to the network over a third time occasion (e.g., subsequent to the second time occasion).

In some examples, one or more uplink resources used by the UE to send the differential CSI report may be configured by the network. For example, the network (e.g., the gNB) may configure at least two periodic or semi-persistent PUCCH resources with multiple (e.g., different) periodicity lengths. For example, the network may configure (e.g., via the CSI report configuration) a first PUCCH resource configuration corresponding to the first CSI report in the group (e.g., the full CSI report 510). For example, the first PUCCH resource configuration may indicate a long periodicity 520 at which the first CSI report of each CSI report group may be transmitted. Additionally, or alternatively, the network may configure (e.g., via the CSI report configuration) a second PUCCH resource configuration corresponding to remaining CSI reports in the CSI report group (e.g., the one or more partial CSI report). For example, the second PUCCH resource configuration may indicate a short periodicity 525 at which each partial CSI report of each CSI report group may be transmitted. In some examples, the second PUCCH resource configuration (e.g., indicating the short periodicity 525) may consume relatively smaller radio resources on each CSI report occasion than the first PUCCH resource configuration (e.g., indicating the long periodicity 520). That is, partial CSI reports may consume relatively smaller radio resources than the full CSI report.

Additionally or alternatively, the second PUCCH resource configuration (e.g., indicating the short periodicity 525) may have a relatively shorter periodicity than the first PUCCH resource configuration (e.g., indicating the long periodicity 520). In some examples, if a first PUCCH resource (e.g., used to transmit a full CSI report) and the second PUCCH resource (e.g., used to transmit a partial CSI report) occur over a same duration (e.g., in a same slot), the first PUCCH resource may be used by the UE (e.g., the full CSI report may be transmitted over the first PUCCH resource or the full CSI report and the partial CSI report may be transmitted over the first PUCCH resource).

In some examples of distributed differential CSI reporting, the UE may support Type II codebooks, Type II port selection codebooks, enhanced type II codebooks, and enhanced type II port selection codebooks. For Type II codebooks and Type II port selection codebooks, the UE may be configured to transmit a full CSI report that may include a set of spatial domain basis functions and a set of channel coefficients. In such an example, the set of channel coefficients may be associated with the set of spatial domain basis functions. For example, the set of channel coefficients included in the full CSI report may correspond to the spatial domain coefficients. For enhanced type II codebooks and enhanced type II port selection codebooks, the UE may be configured to transmit a full CSI report that may include the set of spatial domain basis functions, the set of channel coefficients, and a set of frequency domain basis functions. In such examples, the set of channel coefficients may be associated with the set of spatial domain basis functions and the set of frequency domain basis functions. For example, the set of channel coefficients included in the full CSI report may correspond the spatial frequency domain coefficients.

In some examples of distributed differential CSI reporting, the UE may support Type II codebooks and Type II port selection codebooks. For Type II codebooks and Type II port selection codebooks, an nth partial CSI report may include (e.g., for each transmit layer (l)) a set of differential channel coefficients (ΔW₂⁽ⁿ⁾) that may be determined in accordance with Equation 8:

$$Δ {W}_{2}^{( n )} = {W}_{2}^{( n )} - {W}_{2}^{( n - 1 )} \qquad ( 8 )$$

in which each differential channel coefficient of the set of differential channel coefficients (ΔW₂⁽ⁿ⁾)) included in the nth partial CSI report may corresponds a channel coefficient difference relative to a respective channel coefficient of another setoff channel coefficients (e.g., included in a previously transmitted CSI report). In some examples, the previously transmitted CSI report may be the full CSI report. In such an example, each differential channel coefficient may be relative to a respective channel coefficient of the set of channel coefficients included in the full CSI report. Additionally, or alternatively, the previously transmitted CSI report may be another partial CSI report. In such an example, each differential channel coefficient may be relative to a respective differential channel coefficient of a set of differential channel coefficients included in a previously transmitted partial CSI report.

Additionally, or alternatively, the UE may support enhanced type II codebooks and enhanced type II port selection codebooks. For enhanced type II codebooks and enhanced type II port selection codebooks, an nth partial CSI report may include (e.g., for each transmit layer (l)) a set of differential channel coefficients (Δ\tilde{W}₂⁽ⁿ⁾) that may be determined in accordance with Equation 9:

$$Δ {\tilde{W}}_{2}^{( n )} = {\tilde{W}}_{2}^{( n )} - {\tilde{W}}_{2}^{( n - 1 )} \qquad ( 9 )$$

in which each differential channel coefficient of the set of differential channel coefficients (Δ\tilde{W}₂⁽ⁿ⁾) included in the nth partial CSI report may corresponds a channel coefficient difference relative to a respective channel coefficient of a another set of channel coefficients included in a previously transmitted CSI report (e.g., included in the full CSI report or a previously transmitted partial CSI report). In some examples, the previously transmitted CSI report may be the full CSI report. In such an example, each differential channel coefficient may be relative to a respective channel coefficient of the set of channel coefficients included in the full CSI report. Additionally, or alternatively, the previously transmitted CSI report may be another partial CSI report. In such an example, each differential channel coefficient may be relative to a respective differential channel coefficient of a set of differential channel coefficients included in a previously transmitted partial CSI report.

In some examples, partial CSI reports that include differential channel coefficients that corresponds a channel coefficient difference relative to a respective differential channel coefficient of a another set of channel coefficients (e.g., included in a previously transmitted CSI report) may reduce the likelihood of CSI reports failing to be received by the network (e.g., may reduce the likelihood of missing CSI reports) and may reduce error propagation, among other possible benefits.

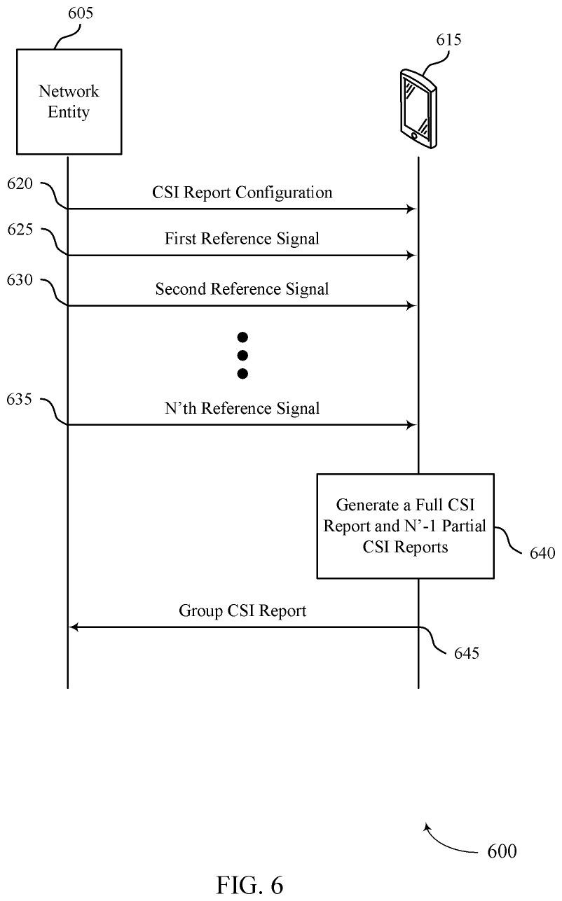

FIG. 6 illustrates an example of a process flow 600 that supports differential CSI reports in accordance with one or more aspects of the present disclosure. In some examples, the process flow 600 may implement or be implemented by one or more aspects of the wireless communications systems 100 and 200. For example, the process flow 600 may be implemented by a network entity 605 and a UE 615, which may be examples of the corresponding devices described with reference to FIGS. 1 and 2. In the following description of the process flow 600, the operations between the UE 615 and the network entity 605 may be performed in different orders or at different times. Some operations may also be omitted.

A wireless communications system may support concentrated differential CSI reporting, in which the quantity of CSI reports (e.g., based on multiple reference signals, multiple CSI-RS, multiple TRS) may be transmitted over a single occasion (e.g., may be transmitted in one slot). In some examples, the network may configure the UE 615 with a quantity of CSI reports that may be grouped. For example, at 620, the UE 615 may receive a CSI report configuration that may indicate a quantity (N′) of reference signal (e.g., CSI-RS or TRS) transmissions (e.g., by the network at different time occasions) or receptions (e.g., at the UE at different time occasions) that may be grouped (e.g., that may be included in a reference signal transmission group). That is, in a message including an indication of the CSI report configuration (e.g., transmitted by the network at 620), the network entity may configure the value of (N′).

At 625, the UE 615 may receive a first reference signal of the reference signal transmission group and at 630 the UE 615 may receive a second reference signal of the reference signal transmission group. Additionally, or alternatively, the UE 615 may receive one or more other reference signals, such that a total number of reference signals transmitted to the UE 615 may correspond to N′. In such an example, at the end of one group (e.g., subsequent to receiving all reference signal included in the reference signal transmission group), the UE 615 may send one CSI report message (e.g., a group CSI report) to the network entity 605 (e.g., the gNB). For example, at 635 the UE 615 may receive an N'th reference signal that may be a relatively last reference signal of the reference signal transmission group. At 640, and in response to response to receiving the N'th reference signal of the reference signal transmission group, the UE may generate a group CSI report that may include one full CSI report (e.g., for a Type-II codebook or enhanced Type-II codebook) based on the relatively last reference signal (e.g., CSI-RS or TRS) reception and N′-1 partial CSI reports (e.g., for a Type-II codebook or an enhanced Type-II codebook) based on each previous reference signal (e.g., CSI-RS) reception. That is, after receiving the quantity of (N′) continuous reference signals (e.g., CSI-RS or TRS) indicated by the message including the CSI report configuration for the reference signal transmission group (e.g., the CSI-RS transmission group, the TRS transmission group), the UE may report a concentrated CSI report (e.g., a group CSI report) including one full CSI for the N'th reference signal reception (e.g., the N'th CSI-RS reception, the N'th TRS reception) and N′-1 partial CSI for each other reference signal reception (e.g., the first to reference signal reception through the N′-1 reference signal reception.

In some examples, the full CSI report may correspond to the N'th reference signal and the one or more partial CSI reports may correspond to reference signals received prior to the N'th reference signal (e.g., the first reference signal and the second reference signal). For Type-II codebooks and Type-II port selection codebooks, the full CSI report may include a set of spatial domain basis functions and a set of channel coefficients. In such examples, the set of channel coefficients may be associated with the set of spatial domain basis functions. For example, the set of channel coefficients included in the full CSI report may correspond spatial domain channel coefficients. Additionally, or alternatively, for enhanced Type-II codebooks and enhanced Type-II port selection codebooks), the full CSI report may include the set of spatial domain basis functions, the set of channel coefficients, and a set of frequency domain basis functions. In such examples, the set of channel coefficients may be associated with the set of spatial domain basis functions and the set of frequency domain basis functions. For example, the set of channel coefficients included in the full CSI report may correspond spatial frequency domain channel coefficients. In some examples, by using one or more measurements performed on the relatively last reference signal (e.g., the relatively last received CSI-RS) for the full CSI report, the UE 615 may enable the network (e.g., the gNB) to perform CSI prediction at the following slots.

Additionally, or alternatively, each (N′-1) partial CSI may include a set of differential channel coefficients, in which each differential channel coefficient of a set of differential channel coefficients may corresponds a channel coefficient difference relative to a respective channel coefficient of the set of channel coefficients (e.g., included in the full CSI report). In some examples, a quantization level (e.g., a quantity of quantization bits used to indicate an amplitude or a phase) of a partial CSI report may increase from low to high with an index associated with each partial CSI report. For example, each partial CSI report may be associated with an index that increases from low (e.g., an index of 1 for the first partial CSI report) to high (e.g., an index of N′-1 for the N′-1th partial CSI report) and the quantization level for each respective partial CSI report may increase with the corresponding index. In some examples, a first portion of partial CSI reports (e.g., the first partial CSI report corresponding to an index of 1 through a partial CSI report corresponding to an index of

$$\frac{{N}^{′}}{3} )$$

may use 1 bit to quantize the amplitude and the phase (e.g., 1 bit for the amplitude and 1 bit for the phase). Additionally, or alternatively, a second portion of partial CSI reports (e.g., a partial CSI report corresponding to an index of

$$\frac{{N}^{′}}{3}$$

through a partial CSI report corresponding to an index of

$$\frac{2 {N}^{′}}{3} )$$

may use 2 bits to quantize the amplitude and phase and a third portion of partial CSI reports (e.g., a partial CSI report corresponding to an index of

$$\frac{2 {N}^{′}}{3}$$

through a partial CSI report corresponding to an index of N′-1) may use 3 bits to quantize the amplitude and the phase. In some examples, by providing partial CSI reports in which the quantization level increases from relatively low to relatively high, the network, (e.g., the gNB) may performs channel status predictions, for example subsequent to receiving the concentrated differential CSI report (e.g., the group CSI report). As such, CSI reports based on reference signals transmitted relatively near (e.g., in time) to a time at which the group CSI report is transmitted may have an increased priority. In some examples, by using different quantization levels for the partial CSI reports, the UE 615 may decrease overhead at the UE 615 (e.g., may decrease the uplink control information size).

At 645, the UE 615 may transmit the group CSI report to the network. In some examples, by transmitting the group CSI report to the network entity 605 the UE 615 may reduce signaling overhead and increase CSI reporting within the wireless communications system, among other possible benefits.

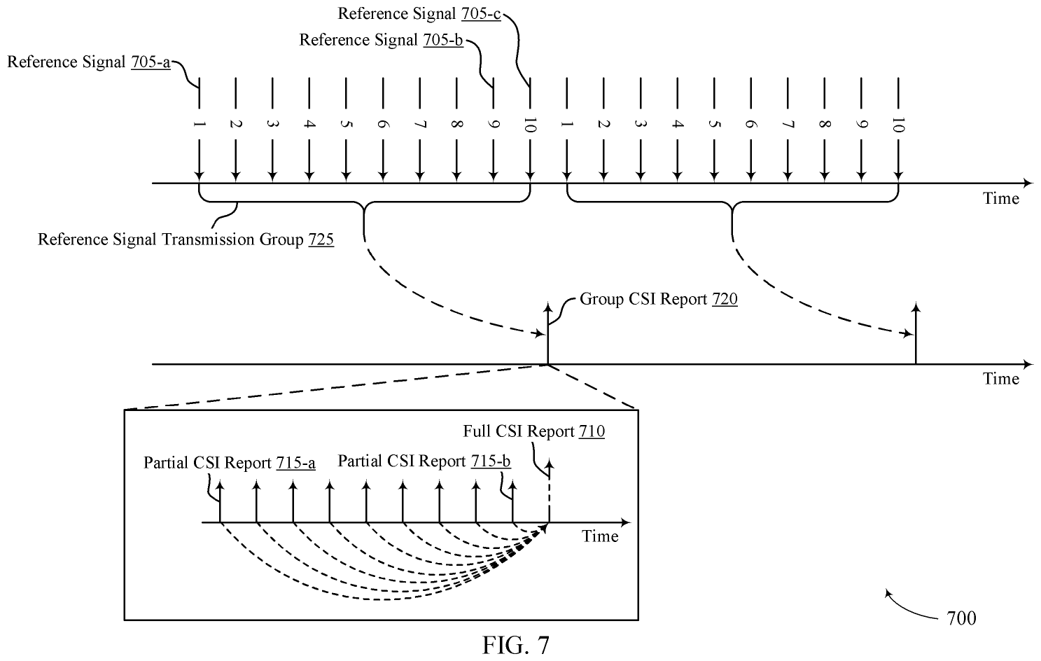

FIG. 7 illustrates an example of a timing diagram 700 that supports differential CSI reports in accordance with one or more aspects of the present disclosure. In some examples, the timing diagram 700 may implement or be implemented by one or more aspects of the wireless communications systems 100 and 200. For example, the timing diagram 700 may be implemented by a network entity and a UE, which may be examples of the corresponding devices described with reference to FIGS. 1 and 2.

In some examples of concentrated differential CSI reporting, each set of differential channel coefficients (e.g., included in one or more partial CSI reports 715) may be associated with a full CSI report 710. For example, as illustrated in the example of FIG. 7, the network may transmit a quantity of reference signals (e.g., one or more reference signals 705 indexed from 1 to 10, a reference signal transmission group 725) to be used by the UE for the concentrated differential CSI report (e.g., a group CSI report 720). In some examples, based on the CSI report configuration, the UE may generate the group CSI report 720 that may include the full CSI report 710 and one or more partial CSI reports 715. In some examples, the full CSI report 710 may be based on one or more measurements performed by the UE on a reference signal 705-c (e.g., a CSI-RS or a TRS). The reference signal 705-c may be a relatively last received reference signal of a group of reference signals received by the UE for the CSI report group. In some examples, the group CSI report 720 may include a first partial CSI report (e.g., a partial CSI report 715-b) that may be based on one or more measurements performed by the UE on a reference signal 705-b (e.g., another CSI-RS or another TRS). The reference signal 705-b may be received by the UE prior to the reference signal 705-c. Additionally, or alternatively, the group CSI report 720 may include a second partial CSI report (e.g., a partial CSI report 715-a) that may be based on one or more measurements performed by the UE on a reference signal 705-a (e.g., another CSI-RS or another TRS). The reference signal 705-a may be a received by the UE prior to the reference signal 705-b. The UE may transmit the group CSI report 720 to the network.

In some examples of concentrated differential CSI reporting, each partial CSI report 715 may include a set of differential channel coefficients (ΔW₂⁽ⁿ⁾). For Type II codebooks and Type II port selection codebooks an nth each partial CSI report may include a set of differential channel coefficients (ΔW₂⁽ⁿ⁾) that may be determined in accordance with Equation 10:

$$Δ {W}_{2}^{( n )} = {W}_{2}^{( n )} - {W}_{2}^{( {N}^{′} )} \qquad ( 10 )$$

in which each differential channel coefficient of the set of differential channel coefficients (ΔW₂⁽ⁿ⁾) included in the nth partial CSI report may corresponds a channel coefficient difference relative to a respective channel coefficient (e.g., a respective spatial channel coefficient) of the set of channel coefficients (e.g., included in the full CSI report).

Additionally, or alternatively, for enhanced type II codebooks and enhanced type II port selection codebooks, an nth partial CSI report may include a set of differential channel coefficients (Δ\tilde{W}₂⁽ⁿ⁾) that may be determined in accordance with Equation 11:

$$Δ {\tilde{W}}_{2}^{( n )} = {\tilde{W}}_{2}^{( n )} - {\tilde{W}}_{2}^{( n - 1 )} \qquad ( 11 )$$

in which each differential channel coefficient of the set of differential channel coefficients (Δ\tilde{W}₂⁽ⁿ⁾) included in the nth partial CSI report may corresponds a channel coefficient difference relative to a respective channel coefficient (e.g., a respective spatial frequency channel coefficient) of the set of channel coefficients (e.g., included in the full CSI report).

In some examples, by transmitting a group CSI report (e.g., a concentrated CSI report) a complexity associated with CSI reporting may be reduced at the UE, among other possible benefits. Additionally, or alternatively, the UE may avoid relatively frequent uplink control information resource grants (e.g., from the network). For example, by using different quantization levels for different partial CSI reports, the UE may decrease the uplink control information size, among other possible benefits.

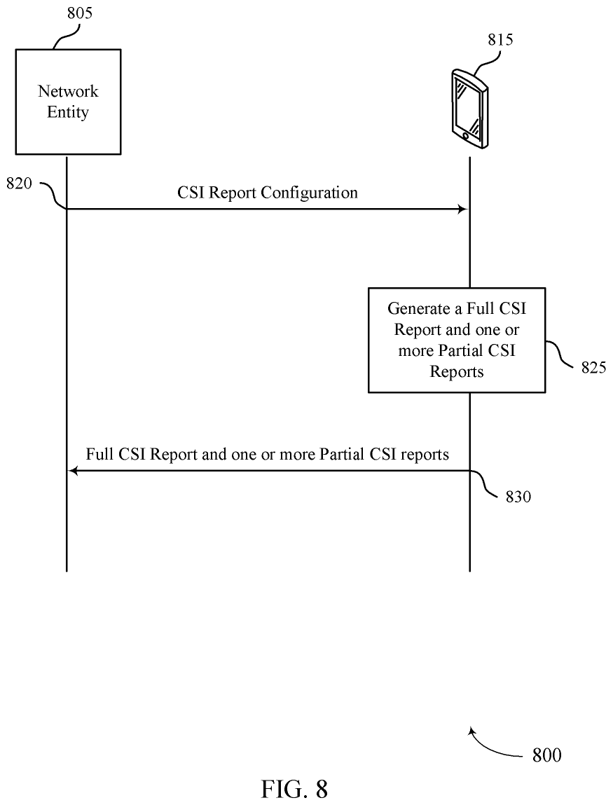

FIG. 8 illustrates an example of a process flow 800 that supports differential CSI reports in accordance with one or more aspects of the present disclosure. In some examples, the process flow 800 may implement or be implemented by one or more aspects of the wireless communications systems 100 and 200. For example, the process flow 800 may be implemented by a network entity 805 and a UE 815, which may be examples of the corresponding devices described with reference to FIGS. 1 and 2. In the following description of the process flow 800, the operations between the UE 815 and the network entity 805 may be performed in different orders or at different times. Some operations may also be omitted.

A wireless communications system may support one or more techniques for differential CSI reports. For example, at 820, the UE 815 may receive a message (e.g., from one or more network entities) that indicates a CSI report configuration. In some examples, the CSI report configuration may be an example of a CSI report configuration as described with reference to FIGS. 2 through 7. For example, the CSI report configuration may identify a quantity of CSI reports to be transmitted by the UE 815.

At 825, the UE 115 may generate a full CSI report and one or more partial CSI reports based on the CSI report configuration. In some examples, the full CSI report may be an example of a full CSI report as described with reference to FIGS. 2 through 8. For example, the full CSI report may include at least a set of spatial domain basis functions and a set of channel coefficients associated with the set of spatial domain basis functions. In some examples, the one or more partial CSI reports may be an example of partial CSI reports as described with reference to FIGS. 2 through 8. For example, the one or more partial CSI reports may each include a respective set of differential channel coefficients.

At 830, the UE 815 may transmit the quantity of CSI reports to the network entity 805). The quantity of CSI reports may include the full CSI report and the one or more partial CSI reports. In some examples, by transmitting the quantity of CSI reports, the UE 815 may reduce overhead associated with CSI reporting and improve throughput within the wireless communications system, among other possible benefits.

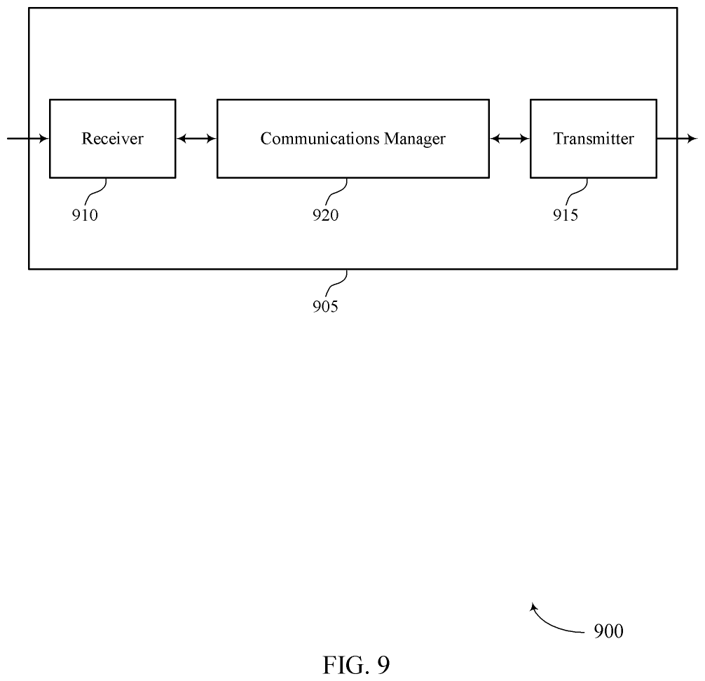

FIG. 9 shows a block diagram 900 of a device 905 that supports differential CSI reports in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to differential CSI reports). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to differential CSI reports). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of differential CSI reports as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE (e.g., device 905) in accordance with examples as disclosed herein. For example, the communications manager 920 may be configured as or otherwise support a means for receiving a message that indicates a CSI report configuration that identifies a quantity of CSI reports to be transmitted by the UE. The communications manager 920 may be configured as or otherwise support a means for generating, based on the CSI report configuration, a full CSI report and one or more partial CSI reports, where the full CSI report includes at least a set of spatial domain basis functions and a set of channel coefficients associated with the set of spatial domain basis functions, and where the one or more partial CSI reports each include a respective set of differential channel coefficients. The communications manager 920 may be configured as or otherwise support a means for transmitting the quantity of CSI reports, where the quantity of CSI reports includes the full CSI report and the one or more partial CSI reports.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced processing and more efficient utilization of communication resources.

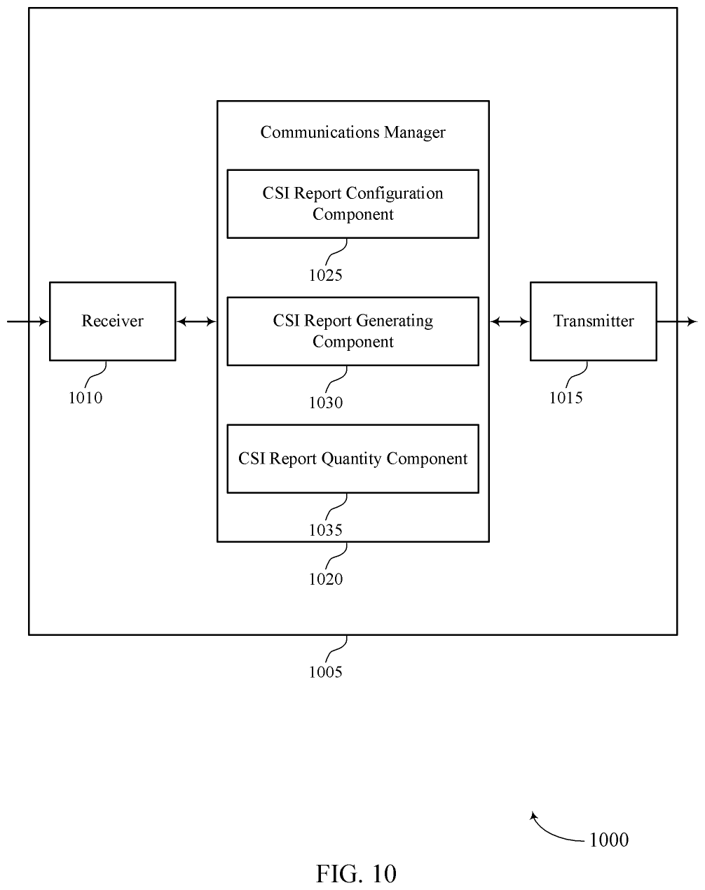

FIG. 10 shows a block diagram 1000 of a device 1005 that supports differential CSI reports in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to differential CSI reports). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to differential CSI reports). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of differential CSI reports as described herein. For example, the communications manager 1020 may include a CSI report configuration component 1025, a CSI report generating component 1030, a CSI report quantity component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a UE (e.g., the device 1005) in accordance with examples as disclosed herein. The CSI report configuration component 1025 may be configured as or otherwise support a means for receiving a message that indicates a CSI report configuration that identifies a quantity of CSI reports to be transmitted by the UE. The CSI report generating component 1030 may be configured as or otherwise support a means for generating, based on the CSI report configuration, a full CSI report and one or more partial CSI reports, where the full CSI report includes at least a set of spatial domain basis functions and a set of channel coefficients associated with the set of spatial domain basis functions, and where the one or more partial CSI reports each include a respective set of differential channel coefficients. The CSI report quantity component 1035 may be configured as or otherwise support a means for transmitting the quantity of CSI reports, where the quantity of CSI reports includes the full CSI report and the one or more partial CSI reports.

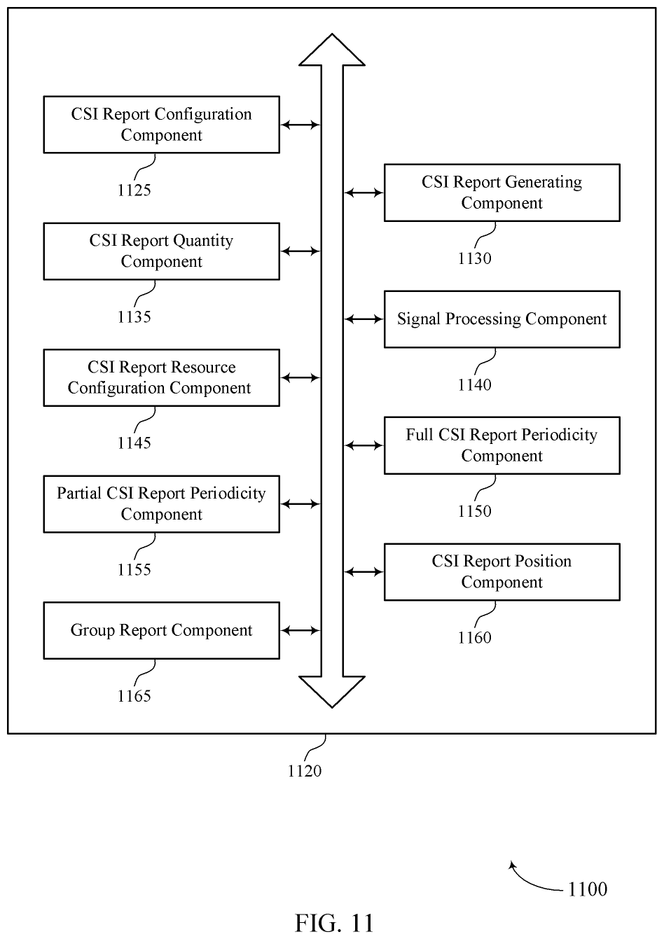

FIG. 11 shows a block diagram 1100 of a communications manager 1120 that supports differential CSI reports in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of differential CSI reports as described herein. For example, the communications manager 1120 may include a CSI report configuration component 1125, a CSI report generating component 1130, a CSI report quantity component 1135, a signal processing component 1140, a CSI report resource configuration component 1145, a full CSI report periodicity component 1150, a partial CSI report periodicity component 1155, a CSI report position component 1160, a group report component 1165, or any combination thereof. Each of these components may communicate, directly or indirectly, with one another (e.g., via one or more buses).

The communications manager 1120 may support wireless communication at a UE in accordance with examples as disclosed herein. The CSI report configuration component 1125 may be configured as or otherwise support a means for receiving a message that indicates a CSI report configuration that identifies a quantity of CSI reports to be transmitted by the UE. The CSI report generating component 1130 may be configured as or otherwise support a means for generating, based on the CSI report configuration, a full CSI report and one or more partial CSI reports, where the full CSI report includes at least a set of spatial domain basis functions and a set of channel coefficients associated with the set of spatial domain basis functions, and where the one or more partial CSI reports each include a respective set of differential channel coefficients. The CSI report quantity component 1135 may be configured as or otherwise support a means for transmitting the quantity of CSI reports, where the quantity of CSI reports includes the full CSI report and the one or more partial CSI reports.

In some examples, to support generating the full CSI report and the one or more partial CSI reports, the signal processing component 1140 may be configured as or otherwise support a means for receiving first signaling and second signaling over a channel for the wireless communication at the UE, the second signaling being received at the UE subsequent to the first signaling. In some examples, to support generating the full CSI report and the one or more partial CSI reports, the CSI report generating component 1130 may be configured as or otherwise support a means for generating the full CSI report based on the first signaling and a first partial CSI report of the one or more partial CSI reports based on the second signaling, where the full CSI report is transmitted over a first time occasion and the first partial CSI report is transmitted over a second time occasion subsequent to the first time occasion.

In some examples, the first partial CSI report includes a first set of differential channel coefficients and each differential channel coefficient of the first set of differential channel coefficients corresponds to a first channel coefficient difference relative to a respective channel coefficient of the set of channel coefficients. In some examples, a number of bits used to represent each differential channel coefficient in the first partial CSI report having a non-zero value is less than a number of bits used to represent respective channel coefficients in the full CSI report.

In some examples, the signal processing component 1140 may be configured as or otherwise support a means for receiving third signaling over the channel for the wireless communication at the UE, the third signaling being received at the UE subsequent to the second signaling. In some examples, the CSI report generating component 1130 may be configured as or otherwise support a means for generating a second partial CSI report of the one or more partial CSI reports based on the third signaling, where the second partial CSI report includes a second set of differential channel coefficients and each differential channel coefficient of the second set of differential channel coefficients corresponds to a second channel coefficient difference relative to a respective differential channel coefficient of the first set of differential channel coefficients. In some examples, the CSI report quantity component 1135 may be configured as or otherwise support a means for transmitting the second partial CSI report over a third time occasion subsequent to the second time occasion.

In some examples, the CSI report resource configuration component 1145 may be configured as or otherwise support a means for receiving another message configuring the UE with a first one or more resources for transmitting the full CSI report over the first time occasion and a second one or more resources for transmitting the first partial CSI report over the second time occasion.

In some examples, the full CSI report periodicity component 1150 may be configured as or otherwise support a means for receiving a first resource configuration indicating a first periodicity for transmitting a set of multiple full CSI reports, where the set of multiple full CSI reports includes the full CSI report, and where transmitting the full CSI report over the first time occasion is based on the first resource configuration. In some examples, the partial CSI report periodicity component 1155 may be configured as or otherwise support a means for receiving a second resource configuration indicating a second periodicity for transmitting the one or more partial CSI reports, where transmitting the first partial CSI report over the second time occasion is based on the second resource configuration, and where a first length of the first periodicity is different from a second length of the second periodicity.

In some examples, the CSI report configuration indicates a set of multiple resources for receiving the first signaling and the second signaling. In some examples, the set of multiple resources are periodic resources or semi-persistent resources, where receiving first signaling and second signaling further includes receiving the first signaling over a first one or more resources of the set of multiple resources and the second signaling over a second one or more resources of the set of multiple resources based on the CSI report configuration.

In some examples, the quantity of CSI reports includes a CSI report group. In some examples, the quantity of CSI reports is identified based on a CSI report group size indicated by the CSI report configuration. In some examples, the CSI report configuration further indicates for each partial CSI report included in the CSI report group to be associated with the full CSI report or a preceding partial CSI report. In some examples, generating the one or more partial CSI reports is based on the CSI report configuration.

In some examples, the CSI report position component 1160 may be configured as or otherwise support a means for receiving another message indicating a position of a CSI report of the CSI report group to be retransmitted by the UE, where the position corresponds to a first position associated with the full CSI report or a second position associated with a partial CSI report of the one or more partial CSI reports. In some examples, the CSI report quantity component 1135 may be configured as or otherwise support a means for retransmitting the full CSI report or the partial CSI report based on the position.

In some examples, to support generating the full CSI report and the one or more partial CSI reports, the signal processing component 1140 may be configured as or otherwise support a means for receiving first signaling and second signaling over a channel for the wireless communication at the UE, the second signaling being received at the UE subsequent to the first signaling. In some examples, to support generating the full CSI report and the one or more partial CSI reports, the CSI report generating component 1130 may be configured as or otherwise support a means for generating the full CSI report based on the second signaling and a first partial CSI report of the one or more partial CSI reports based on the first signaling.

In some examples, to support transmitting the quantity of CSI reports, the group report component 1165 may be configured as or otherwise support a means for transmitting the full CSI report and the first partial CSI report in a group report for the reference signal transmission group. In some examples, the CSI report configuration includes an indication of the reference signal transmission group. In some examples, the quantity of CSI reports is identified based on a size of the reference signal transmission group.

In some examples, the signal processing component 1140 may be configured as or otherwise support a means for receiving third signaling over the channel for the wireless communication at the UE, the third signaling being received at the UE prior to the first signaling and the second signaling. In some examples, the CSI report generating component 1130 may be configured as or otherwise support a means for generating a second partial CSI report of the one or more partial CSI reports based on the third signaling, where the full CSI report, the first partial CSI report, and the second partial CSI report are transmitted in the group report for the reference signal transmission group, and where a number of bits included in the first partial CSI report is greater than a number of bits included in the second partial CSI report.

In some examples, the full CSI report further includes a set of frequency domain basis functions. In some examples, the set of channel coefficients includes a set of spatial frequency domain channel coefficients associated with the set of spatial domain basis functions and the set of frequency domain basis functions.

In some examples, a position of each differential channel coefficient of a set of differential channel coefficients corresponds to a same position or a different position as a respective spatial frequency domain channel coefficient of the set of spatial frequency domain channel coefficients.

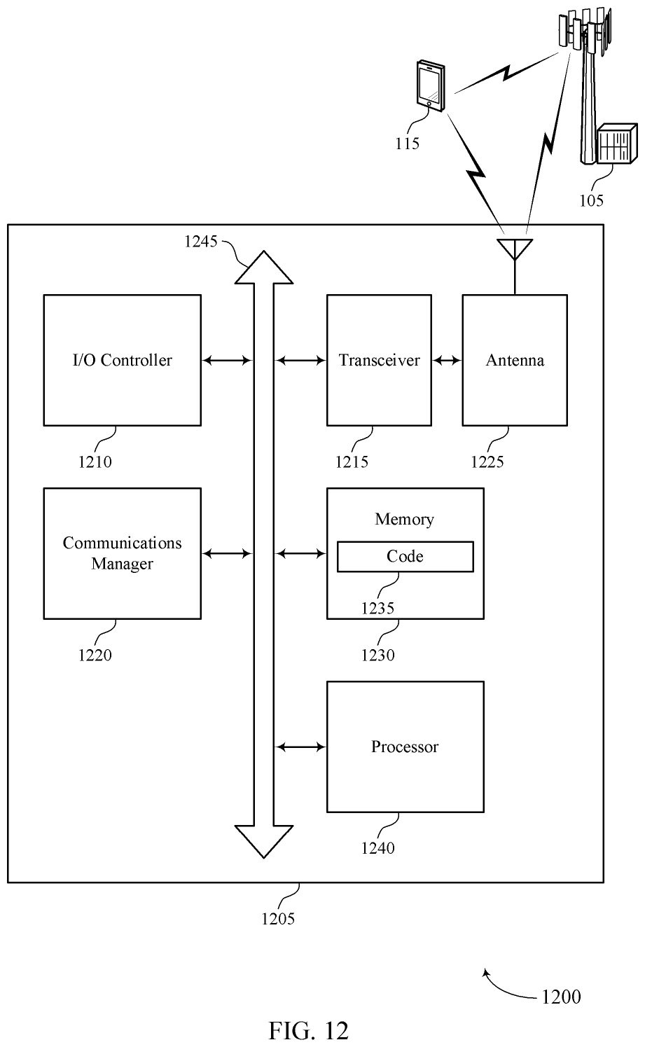

FIG. 12 shows a diagram of a system 1200 including a device 1205 that supports differential CSI reports in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOSR, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting differential CSI reports). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communication at a UE (e.g., the device 1205) in accordance with examples as disclosed herein. For example, the communications manager 1220 may be configured as or otherwise support a means for receiving a message that indicates a CSI report configuration that identifies a quantity of CSI reports to be transmitted by the UE. The communications manager 1220 may be configured as or otherwise support a means for generating, based on the CSI report configuration, a full CSI report and one or more partial CSI reports, where the full CSI report includes at least a set of spatial domain basis functions and a set of channel coefficients associated with the set of spatial domain basis functions, and where the one or more partial CSI reports each include a respective set of differential channel coefficients. The communications manager 1220 may be configured as or otherwise support a means for transmitting the quantity of CSI reports, where the quantity of CSI reports includes the full CSI report and the one or more partial CSI reports.

By including or configuring the communications manager 1220 in accordance with examples as described herein, the device 1205 may support techniques for improved communication reliability, reduced latency, improved user experience related to reduced processing, more efficient utilization of communication resources, and improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of differential CSI reports as described herein, or the processor 1240 and the memory 1230 may be otherwise configured to perform or support such operations.

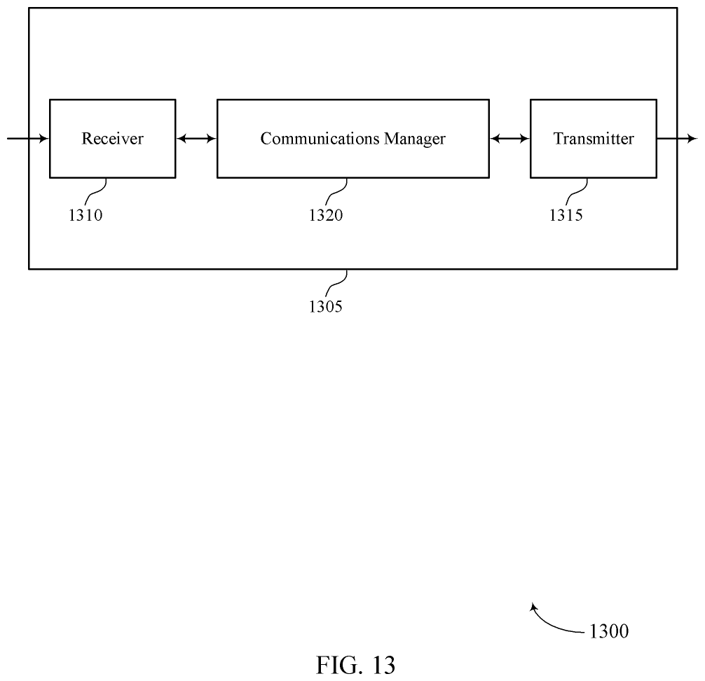

FIG. 13 shows a block diagram 1300 of a device 1305 that supports differential CSI reports in accordance with one or more aspects of the present disclosure. The device 1305 may be an example of aspects of a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations thereof or various components thereof may be examples of means for performing various aspects of differential CSI reports as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a network entity (e.g., device 1305) in accordance with examples as disclosed herein. For example, the communications manager 1320 may be configured as or otherwise support a means for outputting a message that indicates a CSI report configuration that identifies a quantity of CSI reports to be transmitted by a UE. The communications manager 1320 may be configured as or otherwise support a means for obtaining the quantity of CSI reports, where the quantity of CSI reports includes a full CSI report that includes at least a set of spatial domain basis functions and a set of channel coefficients associated with the set of spatial domain basis functions and one or more partial CSI reports that each include a respective set of differential channel coefficients.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for reduced processing and more efficient utilization of communication resources.

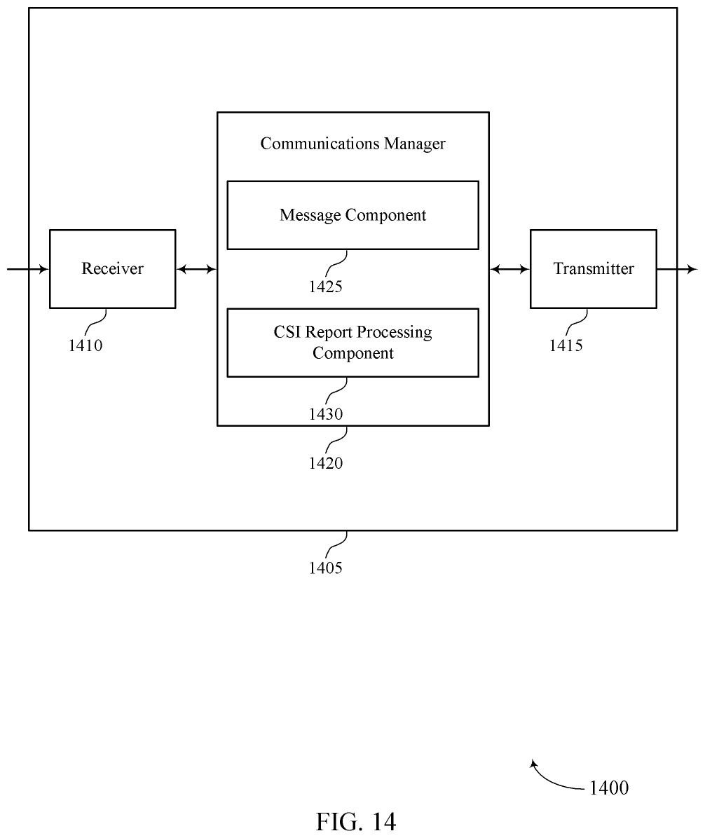

FIG. 14 shows a block diagram 1400 of a device 1405 that supports differential CSI reports in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of differential CSI reports as described herein. For example, the communications manager 1420 may include a message component 1425 a CSI report processing component 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication at a network entity (e.g., device 1405) in accordance with examples as disclosed herein. The message component 1425 may be configured as or otherwise support a means for outputting a message that indicates a CSI report configuration that identifies a quantity of CSI reports to be transmitted by a UE. The CSI report processing component 1430 may be configured as or otherwise support a means for obtaining the quantity of CSI reports, where the quantity of CSI reports includes a full CSI report that includes at least a set of spatial domain basis functions and a set of channel coefficients associated with the set of spatial domain basis functions and one or more partial CSI reports that each include a respective set of differential channel coefficients.

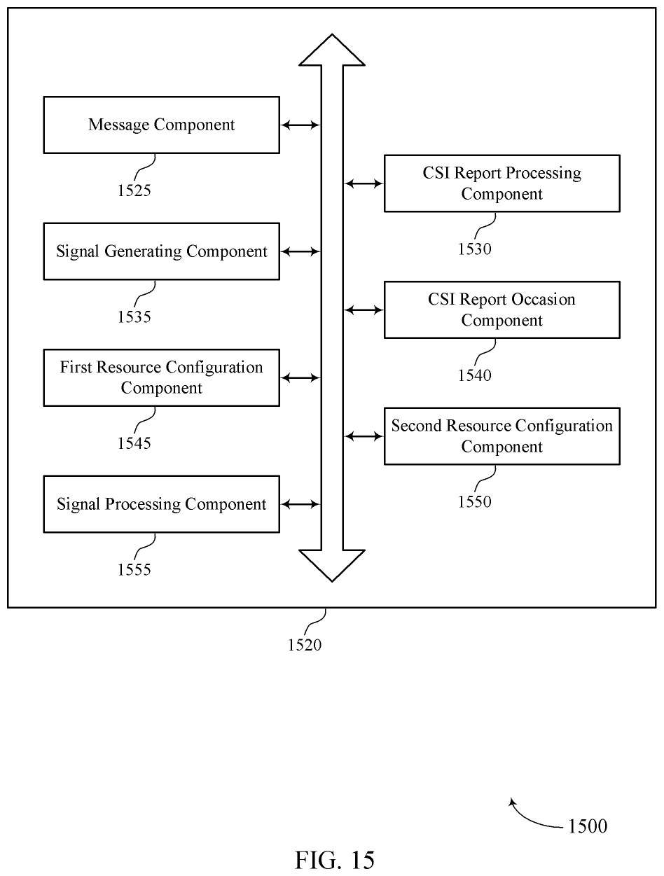

FIG. 15 shows a block diagram 1500 of a communications manager 1520 that supports differential CSI reports in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of differential CSI reports as described herein. For example, the communications manager 1520 may include a message component 1525, a CSI report processing component 1530, a signal generating component 1535, a CSI report occasion component 1540, a first resource configuration component 1545, a second resource configuration component 1550, a signal processing component 1555, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communication at a network entity in accordance with examples as disclosed herein. The message component 1525 may be configured as or otherwise support a means for outputting a message that indicates a CSI report configuration that identifies a quantity of CSI reports to be transmitted by a UE. The CSI report processing component 1530 may be configured as or otherwise support a means for obtaining the quantity of CSI reports, where the quantity of CSI reports includes a full CSI report that includes at least a set of spatial domain basis functions and a set of channel coefficients associated with the set of spatial domain basis functions and one or more partial CSI reports that each include a respective set of differential channel coefficients.

In some examples, the signal generating component 1535 may be configured as or otherwise support a means for outputting first signaling and second signaling over a channel for wireless communications with the UE, the second signaling being output subsequent to the first signaling, where the full CSI report is based on the first signaling and a first partial CSI report of the one or more partial CSI reports is based on the second signaling, and where the full CSI report is obtained over a first time occasion and the first partial CSI report is obtained over a second time occasion subsequent to the first time occasion.

In some examples, the first partial CSI report includes a first set of differential channel coefficients and each differential channel coefficient of the first set of differential channel coefficients corresponds to a first channel coefficient difference relative to a respective channel coefficient of the set of channel coefficients. In some examples, a number of bits used to represent each differential channel coefficient in the first partial CSI report having a non-zero value is less than a number of bits used to represent respective channel coefficients in the full CSI report.

In some examples, the signal generating component 1535 may be configured as or otherwise support a means for outputting third signaling over the channel for the wireless communications with the UE, the third signaling being output subsequent to the second signaling. In some examples, the CSI report processing component 1530 may be configured as or otherwise support a means for obtaining a second partial CSI report of the one or more partial CSI reports based on the third signaling, where the second partial CSI report includes a second set of differential channel coefficients and each differential channel coefficient of the second set of differential channel coefficients corresponds to a second channel coefficient difference relative to a respective differential channel coefficient of the first set of differential channel coefficients, and where the second partial CSI report is obtained over a third time occasion subsequent to the second time occasion.

In some examples, the CSI report occasion component 1540 may be configured as or otherwise support a means for outputting another message configuring the UE with a first one or more resources for transmitting the full CSI report over the first time occasion and a second one or more resources for transmitting the first partial CSI report over the second time occasion.

In some examples, the first resource configuration component 1545 may be configured as or otherwise support a means for outputting a first resource configuration indicating a first periodicity for transmitting, by the UE, a set of multiple full CSI reports, where the set of multiple full CSI reports includes the full CSI report, and where obtaining the full CSI report over the first time occasion is based on the first resource configuration. In some examples, the second resource configuration component 1550 may be configured as or otherwise support a means for outputting a second resource configuration indicating a second periodicity for transmitting, by the UE, the one or more partial CSI reports, where obtaining the first partial CSI report over the second time occasion is based on the second resource configuration, and where a first length of the first periodicity is different from a second length of the second periodicity.

In some examples, the CSI report configuration indicates a set of multiple resources for receiving the first signaling and the second signaling. In some examples, the set of multiple resources are periodic resources or semi-persistent resources, where outputting first signaling and second signaling further includes outputting the first signaling over a first one or more resources of the set of multiple resources and the second signaling over a second one or more resources of the set of multiple resources based on the CSI report configuration.

In some examples, the quantity of CSI reports includes a CSI report group. In some examples, the quantity of CSI reports is identified based on a CSI report group size indicated by the CSI report configuration. In some examples, the CSI report configuration further indicates for each partial CSI report included in the CSI report group to be associated with the full CSI report or a preceding partial CSI report. In some examples, the one or more partial CSI reports are based on the CSI report configuration.

In some examples, the message component 1525 may be configured as or otherwise support a means for outputting another message indicating a position of a CSI report of the CSI report group to be retransmitted by the UE, where the position corresponds to a first position associated with the full CSI report or a second position associated with a partial CSI report of the one or more partial CSI reports. In some examples, the CSI report processing component 1530 may be configured as or otherwise support a means for obtaining the full CSI report or the partial CSI report based on the position.

In some examples, the signal generating component 1535 may be configured as or otherwise support a means for outputting first signaling and second signaling over a channel for wireless communications with the UE, the second signaling being output subsequent to the first signaling, where the full CSI report is based on the second signaling and a first partial CSI report of the one or more partial CSI reports is based on the first signaling.

In some examples, to support obtaining the quantity of CSI reports, the CSI report processing component 1530 may be configured as or otherwise support a means for obtaining the full CSI report and the first partial CSI report in a group report for the reference signal transmission group. In some examples, the CSI report configuration includes an indication of the reference signal transmission group. In some examples, the quantity of CSI reports is identified based on a size of the reference signal transmission group.

In some examples, the signal processing component 1555 may be configured as or otherwise support a means for outputting third signaling over the channel for the wireless communications with the UE, the third signaling being output prior to the first signaling and the second signaling. In some examples, the CSI report processing component 1530 may be configured as or otherwise support a means for obtaining a second partial CSI report of the one or more partial CSI reports based on the third signaling, where the full CSI report, the first partial CSI report, and the second partial CSI report are obtained via the group report for the reference signal transmission group, and where the first partial CSI report includes a number of bits greater than the second partial CSI report.

In some examples, the full CSI report further includes a set of frequency domain basis functions. In some examples, the set of channel coefficients includes a set of spatial frequency domain channel coefficients associated with the set of spatial domain basis functions and the set of frequency domain basis functions. In some examples, a position of each differential channel coefficient of a set of differential channel coefficients corresponds to a same position or a different position as a respective spatial frequency domain channel coefficient of the set of spatial frequency domain channel coefficients.

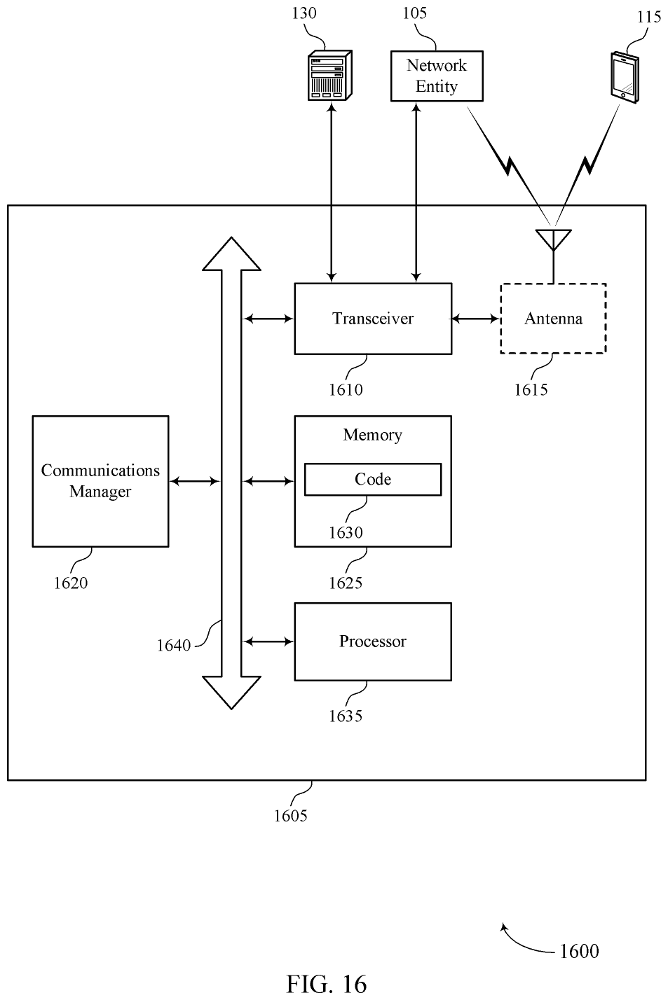

FIG. 16 shows a diagram of a system 1600 including a device 1605 that supports differential CSI reports in accordance with one or more aspects of the present disclosure. The device 1605 may be an example of or include the components of a device 1305, a device 1405, or a network entity 105 as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, a memory 1625, code 1630, and a processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. The transceiver 1610, or the transceiver 1610 and one or more antennas 1615 or wired interfaces, where applicable, may be an example of a transmitter 1315, a transmitter 1415, a receiver 1310, a receiver 1410, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1625 may include RAM and ROM. The memory 1625 may store computer-readable, computer-executable code 1630 including instructions that, when executed by the processor 1635, cause the device 1605 to perform various functions described herein. The code 1630 may be stored in a non-transitory computer-readable medium such as system memory or another type of memory. In some cases, the code 1630 may not be directly executable by the processor 1635 but may cause a computer (e.g., when compiled and executed) to perform functions described herein. In some cases, the memory 1625 may contain, among other things, a BIOS which may control basic hardware or software operation such as the interaction with peripheral components or devices.

The processor 1635 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1635 may be configured to operate a memory array using a memory controller. In some other cases, a memory controller may be integrated into the processor 1635. The processor 1635 may be configured to execute computer-readable instructions stored in a memory (e.g., the memory 1625) to cause the device 1605 to perform various functions (e.g., functions or tasks supporting differential CSI reports). For example, the device 1605 or a component of the device 1605 may include a processor 1635 and memory 1625 coupled with the processor 1635, the processor 1635 and memory 1625 configured to perform various functions described herein. The processor 1635 may be an example of a cloud-computing platform (e.g., one or more physical nodes and supporting software such as operating systems, virtual machines, or container instances) that may host the functions (e.g., by executing code 1630) to perform the functions of the device 1605.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the memory 1625, the code 1630, and the processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with other network entities 105, and may include a controller or scheduler for controlling communications with UEs 115 in cooperation with other network entities 105. In some examples, the communications manager 1620 may support an X2 interface within an LTE/LTE-A wireless communications network technology to provide communication between network entities 105.

The communications manager 1620 may support wireless communication at a network entity (e.g., the device 1605) in accordance with examples as disclosed herein. For example, the communications manager 1620 may be configured as or otherwise support a means for outputting a message that indicates a CSI report configuration that identifies a quantity of CSI reports to be transmitted by a UE. The communications manager 1620 may be configured as or otherwise support a means for obtaining the quantity of CSI reports, where the quantity of CSI reports includes a full CSI report that includes at least a set of spatial domain basis functions and a set of channel coefficients associated with the set of spatial domain basis functions and one or more partial CSI reports that each include a respective set of differential channel coefficients.

By including or configuring the communications manager 1620 in accordance with examples as described herein, the device 1605 may support techniques for improved communication reliability, reduced latency, improved user experience related to reduced processing, more efficient utilization of communication resources, and improved utilization of processing capability.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the processor 1635, the memory 1625, the code 1630, the transceiver 1610, or any combination thereof. For example, the code 1630 may include instructions executable by the processor 1635 to cause the device 1605 to perform various aspects of differential CSI reports as described herein, or the processor 1635 and the memory 1625 may be otherwise configured to perform or support such operations.

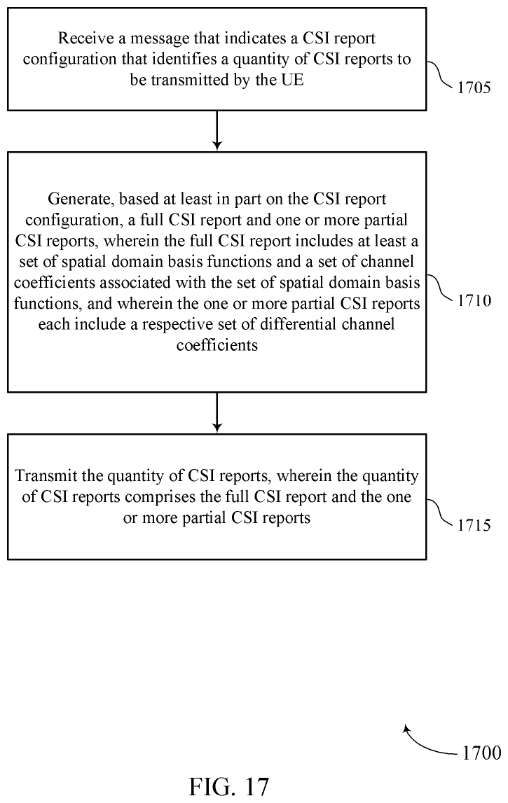

FIG. 17 shows a flowchart illustrating a method 1700 that supports differential CSI reports in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving a message that indicates a CSI report configuration that identifies a quantity of CSI reports to be transmitted by the UE. The operations of 1705 may be performed in accordance with examples as disclosed herein. In some examples, aspects of the operations of 1705 may be performed by a CSI report configuration component 1125 as described with reference to FIG. 11.

At 1710, the method may include generating, based on the CSI report configuration, a full CSI report and one or more partial CSI reports, where the full CSI report includes at least a set of spatial domain basis functions and a set of channel coefficients associated with the set of spatial domain basis functions, and where the one or more partial CSI reports each include a respective set of differential channel coefficients. The operations of 1710 may be performed in accordance with examples as disclosed herein. In some examples, aspects of the operations of 1710 may be performed by a CSI report generating component 1130 as described with reference to FIG. 11.

At 1715, the method may include transmitting the quantity of CSI reports, where the quantity of CSI reports includes the full CSI report and the one or more partial CSI reports. The operations of 1715 may be performed in accordance with examples as disclosed herein. In some examples, aspects of the operations of 1715 may be performed by a CSI report quantity component 1135 as described with reference to FIG. 11.

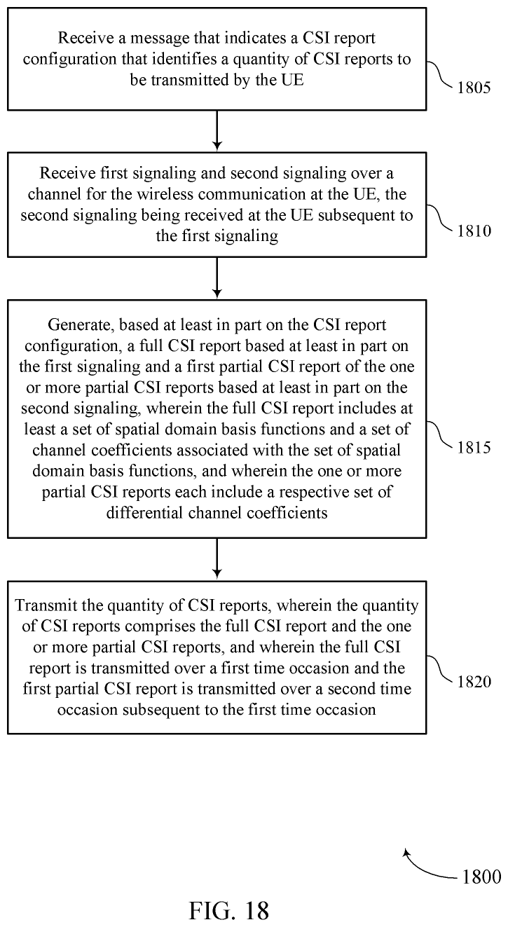

FIG. 18 shows a flowchart illustrating a method 1800 that supports differential CSI reports in accordance with one or more aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, the method may include receiving a message that indicates a CSI report configuration that identifies a quantity of CSI reports to be transmitted by the UE. The operations of 1805 may be performed in accordance with examples as disclosed herein. In some examples, aspects of the operations of 1805 may be performed by a CSI report configuration component 1125 as described with reference to FIG. 11.

At 1810, the method may include receiving first signaling and second signaling over a channel for the wireless communication at the UE, the second signaling being received at the UE subsequent to the first signaling. The operations of 1810 may be performed in accordance with examples as disclosed herein. In some examples, aspects of the operations of 1810 may be performed by a signal processing component 1140 as described with reference to FIG. 11.

At 1815, the method may include generating, based at least in part on the CSI report configuration, the full CSI report based on the first signaling and a first partial CSI report of the one or more partial CSI reports based on the second signaling, where the full CSI report includes at least a set of spatial domain basis functions and a set of channel coefficients associated with the set of spatial domain basis functions, and where the one or more partial CSI reports each include a respective set of differential channel coefficients. The operations of 1815 may be performed in accordance with examples as disclosed herein. In some examples, aspects of the operations of 1815 may be performed by a CSI report generating component 1130 as described with reference to FIG. 11.

At 1820 the method may include transmitting the quantity of CSI reports, where the quantity of CSI reports includes the full CSI report and the one or more partial CSI reports, and where the full CSI report is transmitted over a first time occasion and the first partial CSI report is transmitted over a second time occasion subsequent to the first time occasion. The operations of 1820 may be performed in accordance with examples as disclosed herein. In some examples, aspects of the operations of 1820 may be performed by a CSI report quantity component 1135 as described with reference to FIG. 11.

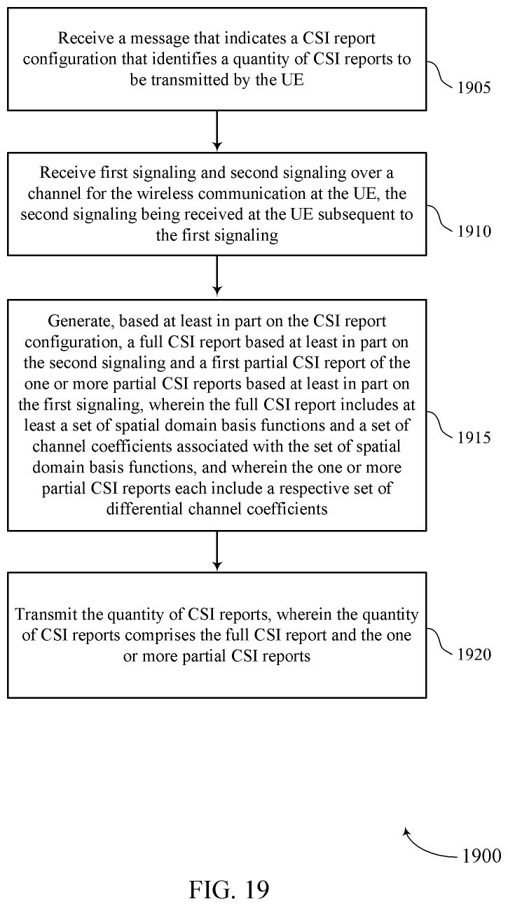

FIG. 19 shows a flowchart illustrating a method 1900 that supports differential CSI reports in accordance with one or more aspects of the present disclosure. The operations of the method 1900 may be implemented by a UE or its components as described herein. For example, the operations of the method 1900 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1905, the method may include receiving a message that indicates a CSI report configuration that identifies a quantity of CSI reports to be transmitted by the UE. The operations of 1905 may be performed in accordance with examples as disclosed herein. In some examples, aspects of the operations of 1905 may be performed by a CSI report configuration component 1125 as described with reference to FIG. 11.

At 1910, the method may include receiving first signaling and second signaling over a channel for the wireless communication at the UE, the second signaling being received at the UE subsequent to the first signaling. The operations of 1910 may be performed in accordance with examples as disclosed herein. In some examples, aspects of the operations of 1910 may be performed by a signal processing component 1140 as described with reference to FIG. 11.

At 1915, the method may include generating, based on the CSI report configuration, the full CSI report based on the second signaling and a first partial CSI report of the one or more partial CSI reports based on the first signaling, where the full CSI report includes at least a set of spatial domain basis functions and a set of channel coefficients associated with the set of spatial domain basis functions, and where the one or more partial CSI reports each include a respective set of differential channel coefficients. The operations of 1915 may be performed in accordance with examples as disclosed herein. In some examples, aspects of the operations of 1915 may be performed by a CSI report generating component 1130 as described with reference to FIG. 11.

At 1920, the method may include transmitting the quantity of CSI reports, where the quantity of CSI reports includes the full CSI report and the one or more partial CSI reports. The operations of 1920 may be performed in accordance with examples as disclosed herein. In some examples, aspects of the operations of 1920 may be performed by a CSI report quantity component 1135 as described with reference to FIG. 11.

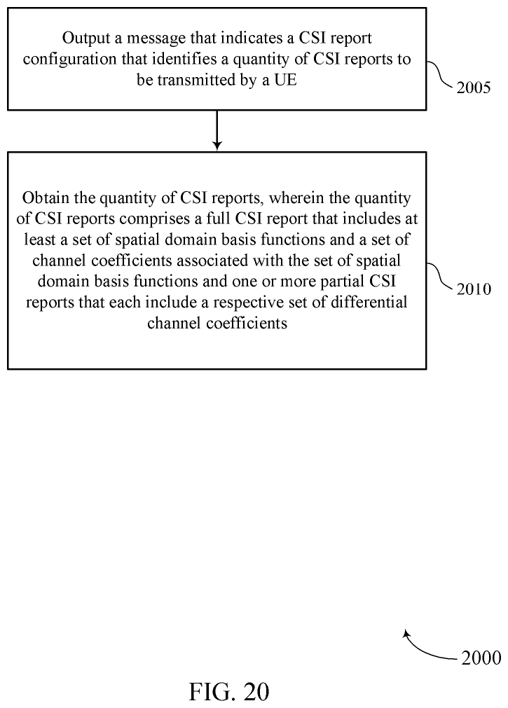

FIG. 20 shows a flowchart illustrating a method 2000 that supports differential CSI reports in accordance with one or more aspects of the present disclosure. The operations of the method 2000 may be implemented by a network entity or its components as described herein. For example, the operations of the method 2000 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2005, the method may include outputting a message that indicates a CSI report configuration that identifies a quantity of CSI reports to be transmitted by a UE. The operations of 2005 may be performed in accordance with examples as disclosed herein. In some examples, aspects of the operations of 2005 may be performed by a message component 1525 as described with reference to FIG. 15.

At 2010, the method may include obtaining the quantity of CSI reports, where the quantity of CSI reports includes a full CSI report that includes at least a set of spatial domain basis functions and a set of channel coefficients associated with the set of spatial domain basis functions and one or more partial CSI reports that each include a respective set of differential channel coefficients. The operations of 2010 may be performed in accordance with examples as disclosed herein. In some examples, aspects of the operations of 2010 may be performed by a CSI report processing component 1530 as described with reference to FIG. 15.

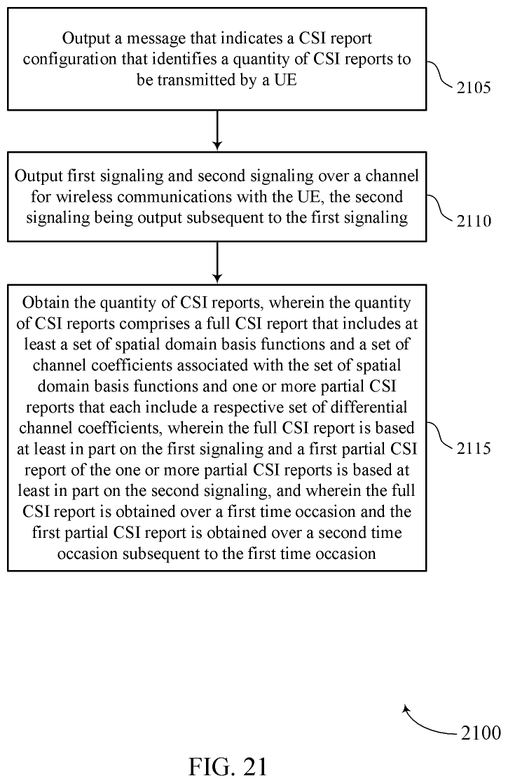

FIG. 21 shows a flowchart illustrating a method 2100 that supports differential CSI reports in accordance with one or more aspects of the present disclosure. The operations of the method 2100 may be implemented by a network entity or its components as described herein. For example, the operations of the method 2100 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2105, the method may include outputting a message that indicates a CSI report configuration that identifies a quantity of CSI reports to be transmitted by a UE. The operations of 2105 may be performed in accordance with examples as disclosed herein. In some examples, aspects of the operations of 2105 may be performed by a message component 1525 as described with reference to FIG. 15.

At 2110, the method may include outputting first signaling and second signaling over a channel for wireless communications with the UE, the second signaling being output subsequent to the first signaling. The operations of 2110 may be performed in accordance with examples as disclosed herein. In some examples, aspects of the operations of 2110 may be performed by a signal generating component 1535 as described with reference to FIG. 15.

At 2115, the method may include obtaining the quantity of CSI reports, where the quantity of CSI reports includes a full CSI report that includes at least a set of spatial domain basis functions and a set of channel coefficients associated with the set of spatial domain basis functions and one or more partial CSI reports that each include a respective set of differential channel coefficients, where the full CSI report is based on the first signaling and a first partial CSI report of the one or more partial CSI reports is based on the second signaling, and where the full CSI report is obtained over a first time occasion and the first partial CSI report is obtained over a second time occasion subsequent to the first time occasion. The operations of 2115 may be performed in accordance with examples as disclosed herein. In some examples, aspects of the operations of 2115 may be performed by a CSI report processing component 1530 as described with reference to FIG. 15.

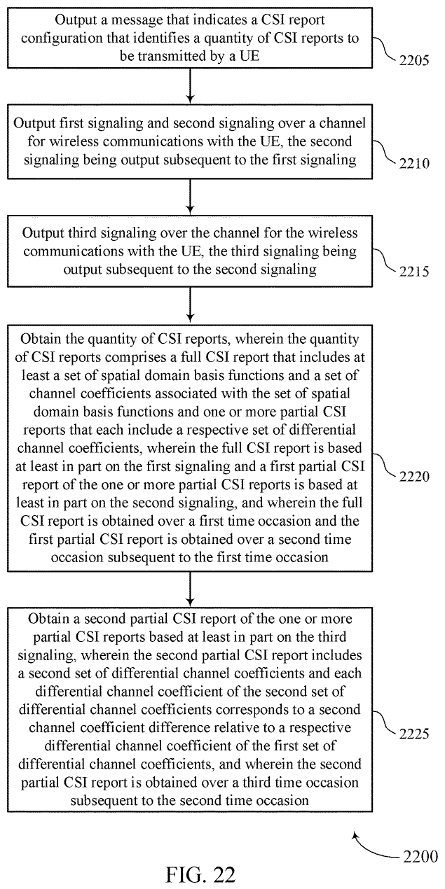

FIG. 22 shows a flowchart illustrating a method 2200 that supports differential CSI reports in accordance with one or more aspects of the present disclosure. The operations of the method 2200 may be implemented by a network entity or its components as described herein. For example, the operations of the method 2200 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2205, the method may include outputting a message that indicates a CSI report configuration that identifies a quantity of CSI reports to be transmitted by a UE. The operations of 2205 may be performed in accordance with examples as disclosed herein. In some examples, aspects of the operations of 2205 may be performed by a message component 1525 as described with reference to FIG. 15.

At 2210, the method may include outputting first signaling and second signaling over a channel for wireless communications with the UE, the second signaling being output subsequent to the first signaling. The operations of 2210 may be performed in accordance with examples as disclosed herein. In some examples, aspects of the operations of 2210 may be performed by a signal generating component 1535 as described with reference to FIG. 15.

At 2215, the method may include outputting third signaling over the channel for the wireless communications with the UE, the third signaling being output subsequent to the second signaling. The operations of 2215 may be performed in accordance with examples as disclosed herein. In some examples, aspects of the operations of 2215 may be performed by a signal generating component 1535 as described with reference to FIG. 15.

At 2220, the method may include obtaining the quantity of CSI reports, where the quantity of CSI reports includes a full CSI report that includes at least a set of spatial domain basis functions and a set of channel coefficients associated with the set of spatial domain basis functions and one or more partial CSI reports that each include a respective set of differential channel coefficients, where the full CSI report is based on the first signaling and a first partial CSI report of the one or more partial CSI reports is based on the second signaling, and where the full CSI report is obtained over a first time occasion and the first partial CSI report is obtained over a second time occasion subsequent to the first time occasion. The operations of 2220 may be performed in accordance with examples as disclosed herein. In some examples, aspects of the operations of 2220 may be performed by a CSI report processing component 1530 as described with reference to FIG. 15.

At 2225, the method may include obtaining a second partial CSI report of the one or more partial CSI reports based on the third signaling, where the second partial CSI report includes a second set of differential channel coefficients and each differential channel coefficient of the second set of differential channel coefficients corresponds to a second channel coefficient difference relative to a respective differential channel coefficient of the first set of differential channel coefficients, and where the second partial CSI report is obtained over a third time occasion subsequent to the second time occasion. The operations of 2225 may be performed in accordance with examples as disclosed herein. In some examples, aspects of the operations of 2225 may be performed by a CSI report processing component 1530 as described with reference to FIG. 15.

The following provides an overview of aspects of the present disclosure:

Aspect 1: A method for wireless communication at a UE, comprising: receiving a message that indicates a CSI report configuration that identifies a quantity of CSI reports to be transmitted by the UE: generating, based at least in part on the CSI report configuration, a full CSI report and one or more partial CSI reports, wherein the full CSI report includes at least a set of spatial domain basis functions and a set of channel coefficients associated with the set of spatial domain basis functions, and wherein the one or more partial CSI reports each include a respective set of differential channel coefficients; and transmitting the quantity of CSI reports, wherein the quantity of CSI reports comprises the full CSI report and the one or more partial CSI reports.

Aspect 2: The method of aspect 1, wherein generating the full CSI report and the one or more partial CSI reports comprises: receiving first signaling and second signaling over a channel for the wireless communication at the UE, the second signaling being received at the UE subsequent to the first signaling; and generating the full CSI report based at least in part on the first signaling and a first partial CSI report of the one or more partial CSI reports based at least in part on the second signaling, wherein the full CSI report is transmitted over a first time occasion and the first partial CSI report is transmitted over a second time occasion subsequent to the first time occasion.

Aspect 3: The method of aspect 2, wherein the first partial CSI report includes a first set of differential channel coefficients and each differential channel coefficient of the first set of differential channel coefficients corresponds to a first channel coefficient difference relative to a respective channel coefficient of the set of channel coefficients.

Aspect 4: The method of aspect 3, wherein a number of bits used to represent each differential channel coefficient in the first partial CSI report having a non-zero value is less than a number of bits used to represent respective channel coefficients in the full CSI report.

Aspect 5: The method of any of aspects 3 through 4, further comprising: receiving third signaling over the channel for the wireless communication at the UE, the third signaling being received at the UE subsequent to the second signaling: generating a second partial CSI report of the one or more partial CSI reports based at least in part on the third signaling, wherein the second partial CSI report includes a second set of differential channel coefficients and each differential channel coefficient of the second set of differential channel coefficients corresponds to a second channel coefficient difference relative to a respective differential channel coefficient of the first set of differential channel coefficients; and transmitting the second partial CSI report over a third time occasion subsequent to the second time occasion.

Aspect 6: The method of any of aspects 2 through 5, further comprising: receiving another message configuring the UE with a first one or more resources for transmitting the full CSI report over the first time occasion and a second one or more resources for transmitting the first partial CSI report over the second time occasion.

Aspect 7: The method of any of aspects 2 through 5, further comprising: receiving a first resource configuration indicating a first periodicity for transmitting a plurality of full CSI reports, wherein the plurality of full CSI reports comprises the full CSI report, and wherein transmitting the full CSI report over the first time occasion is based at least in part on the first resource configuration; and receiving a second resource configuration indicating a second periodicity for transmitting the one or more partial CSI reports, wherein transmitting the first partial CSI report over the second time occasion is based at least in part on the second resource configuration, and wherein a first length of the first periodicity is different from a second length of the second periodicity.

Aspect 8: The method of any of aspects 2 through 7, wherein the CSI report configuration indicates a plurality of resources for receiving the first signaling and the second signaling, and the plurality of resources are periodic resources or semi-persistent resources, wherein receiving first signaling and second signaling further comprises: receiving the first signaling over a first one or more resources of the plurality of resources and the second signaling over a second one or more resources of the plurality of resources based at least in part on the CSI report configuration.

Aspect 9: The method of any of aspects 1 through 8, wherein the quantity of CSI reports comprises a CSI report group, and the quantity of CSI reports is identified based at least in part on a CSI report group size indicated by the CSI report configuration.

Aspect 10: The method of aspect 9, wherein the CSI report configuration further indicates for each partial CSI report included in the CSI report group to be associated with the full CSI report or a preceding partial CSI report, and generating the one or more partial CSI reports is based at least in part on the CSI report configuration.

Aspect 11: The method of any of aspects 9 through 10, further comprising: receiving another message indicating a position of a CSI report of the CSI report group to be retransmitted by the UE, wherein the position corresponds to a first position associated with the full CSI report or a second position associated with a partial CSI report of the one or more partial CSI reports; and retransmitting the full CSI report or the partial CSI report based at least in part on the position.

Aspect 12: The method of aspect 1, wherein generating the full CSI report and the one or more partial CSI reports comprises: receiving first signaling and second signaling over a channel for the wireless communication at the UE, the second signaling being received at the UE subsequent to the first signaling; and generating the full CSI report based at least in part on the second signaling and a first partial CSI report of the one or more partial CSI reports based at least in part on the first signaling.

Aspect 13: The method of aspect 12, wherein the first signaling and the second signaling comprise a reference signal transmission group, and wherein transmitting the quantity of CSI reports comprises: transmitting the full CSI report and the first partial CSI report in a group report for the reference signal transmission group.

Aspect 14: The method of aspect 13, wherein the CSI report configuration comprises an indication of the reference signal transmission group, and the quantity of CSI reports is identified based at least in part on a size of the reference signal transmission group.

Aspect 15: The method of any of aspects 13 through 14, further comprising: receiving third signaling over the channel for the wireless communication at the UE, the third signaling being received at the UE prior to the first signaling and the second signaling; and generating a second partial CSI report of the one or more partial CSI reports based at least in part on the third signaling, wherein the full CSI report, the first partial CSI report, and the second partial CSI report are transmitted in the group report for the reference signal transmission group, and wherein a number of bits included in the first partial CSI report is greater than a number of bits included in the second partial CSI report.

Aspect 16: The method of any of aspects 1 through 15, wherein the full CSI report further comprises a set of frequency domain basis functions, and the set of channel coefficients comprises a set of spatial frequency domain channel coefficients associated with the set of spatial domain basis functions and the set of frequency domain basis functions.

Aspect 17: The method of aspect 16, wherein a position of each differential channel coefficient of a set of differential channel coefficients corresponds to a same position or a different position as a respective spatial frequency domain channel coefficient of the set of spatial frequency domain channel coefficients.

Aspect 18: A method for wireless communication at a network entity, comprising: outputting a message that indicates a CSI report configuration that identifies a quantity of CSI reports to be transmitted by a UE; and obtaining the quantity of CSI reports, wherein the quantity of CSI reports comprises a full CSI report that includes at least a set of spatial domain basis functions and a set of channel coefficients associated with the set of spatial domain basis functions and one or more partial CSI reports that each include a respective set of differential channel coefficients.

Aspect 19: The method of aspect 18, further comprising: outputting first signaling and second signaling over a channel for wireless communications with the UE, the second signaling being output subsequent to the first signaling, wherein the full CSI report is based at least in part on the first signaling and a first partial CSI report of the one or more partial CSI reports is based at least in part on the second signaling, and wherein the full CSI report is obtained over a first time occasion and the first partial CSI report is obtained over a second time occasion subsequent to the first time occasion.

Aspect 20: The method of aspect 19, wherein the first partial CSI report includes a first set of differential channel coefficients and each differential channel coefficient of the first set of differential channel coefficients corresponds to a first channel coefficient difference relative to a respective channel coefficient of the set of channel coefficients.

Aspect 21: The method of aspect 20, wherein a number of bits used to represent each differential channel coefficient in the first partial CSI report having a non-zero value is less than a number of bits used to represent respective channel coefficients in the full CSI report.

Aspect 22: The method of any of aspects 20 through 21, further comprising: outputting third signaling over the channel for the wireless communications with the UE, the third signaling being output subsequent to the second signaling; and obtaining a second partial CSI report of the one or more partial CSI reports based at least in part on the third signaling, wherein the second partial CSI report includes a second set of differential channel coefficients and each differential channel coefficient of the second set of differential channel coefficients corresponds to a second channel coefficient difference relative to a respective differential channel coefficient of the first set of differential channel coefficients, and wherein the second partial CSI report is obtained over a third time occasion subsequent to the second time occasion.

Aspect 23: The method of any of aspects 19 through 22, further comprising: outputting another message configuring the UE with a first one or more resources for transmitting the full CSI report over the first time occasion and a second one or more resources for transmitting the first partial CSI report over the second time occasion.

Aspect 24: The method of any of aspects 19 through 22, further comprising: outputting a first resource configuration indicating a first periodicity for transmitting, by the UE, a plurality of full CSI reports, wherein the plurality of full CSI reports comprises the full CSI report, and wherein obtaining the full CSI report over the first time occasion is based at least in part on the first resource configuration; and outputting a second resource configuration indicating a second periodicity for transmitting, by the UE, the one or more partial CSI reports, wherein obtaining the first partial CSI report over the second time occasion is based at least in part on the second resource configuration, and wherein a first length of the first periodicity is different from a second length of the second periodicity.

Aspect 25: The method of any of aspects 19 through 24, wherein the CSI report configuration indicates a plurality of resources for receiving the first signaling and the second signaling, and the plurality of resources are periodic resources or semi-persistent resources, wherein outputting first signaling and second signaling further comprises: outputting the first signaling over a first one or more resources of the plurality of resources and the second signaling over a second one or more resources of the plurality of resources based at least in part on the CSI report configuration.

Aspect 26: The method of any of aspects 18 through 25, wherein the quantity of CSI reports comprises a CSI report group, and the quantity of CSI reports is identified based at least in part on a CSI report group size indicated by the CSI report configuration.

Aspect 27: The method of aspect 26, wherein the CSI report configuration further indicates for each partial CSI report included in the CSI report group to be associated with the full CSI report or a preceding partial CSI report, and the one or more partial CSI reports are based at least in part on the CSI report configuration.

Aspect 28: The method of any of aspects 26 through 27, further comprising: outputting another message indicating a position of a CSI report of the CSI report group to be retransmitted by the UE, wherein the position corresponds to a first position associated with the full CSI report or a second position associated with a partial CSI report of the one or more partial CSI reports; and obtaining the full CSI report or the partial CSI report based at least in part on the position.

Aspect 29: The method of aspect 18, further comprising: outputting first signaling and second signaling over a channel for wireless communications with the UE, the second signaling being output subsequent to the first signaling, wherein the full CSI report is based at least in part on the second signaling and a first partial CSI report of the one or more partial CSI reports is based at least in part on the first signaling.

Aspect 30: The method of aspect 29, wherein the first signaling and the second signaling comprise a reference signal transmission group, and wherein obtaining the quantity of CSI reports comprises: obtaining the full CSI report and the first partial CSI report in a group report for the reference signal transmission group.

Aspect 31: The method of aspect 30, wherein the CSI report configuration comprises an indication of the reference signal transmission group, and the quantity of CSI reports is identified based at least in part on a size of the reference signal transmission group.

Aspect 32: The method of any of aspects 30 through 31, further comprising: outputting third signaling over the channel for the wireless communications with the UE, the third signaling being output prior to the first signaling and the second signaling; and obtaining a second partial CSI report of the one or more partial CSI reports based at least in part on the third signaling, wherein the full CSI report, the first partial CSI report, and the second partial CSI report are obtained via the group report for the reference signal transmission group, and wherein the first partial CSI report comprises a number of bits greater than the second partial CSI report.

Aspect 33: The method of any of aspects 18 through 32, wherein the full CSI report further comprises a set of frequency domain basis functions, and the set of channel coefficients comprises a set of spatial frequency domain channel coefficients associated with the set of spatial domain basis functions and the set of frequency domain basis functions.

Aspect 34: The method of aspect 33, wherein a position of each differential channel coefficient of a set of differential channel coefficients corresponds to a same position or a different position as a respective spatial frequency domain channel coefficient of the set of spatial frequency domain channel coefficients.

Aspect 35: An apparatus for wireless communication, comprising a processor: memory coupled with the processor; and instructions stored in the memory and executable by the processor to cause the apparatus to perform a method of any of aspects 1 through 17.

Aspect 36: An apparatus for wireless communication, comprising at least one means for performing a method of any of aspects 1 through 17.

Aspect 37: A non-transitory computer-readable medium storing code for wireless communication at a UE, the code comprising instructions executable by a processor to perform a method of any of aspects 1 through 17.

Aspect 38: An apparatus for wireless communication, comprising a processor: memory coupled with the processor; and instructions stored in the memory and executable by the processor to cause the apparatus to perform a method of any of aspects 18 through 34.

Aspect 39: An apparatus for wireless communication, comprising at least one means for performing a method of any of aspects 18 through 34.

Aspect 40: A non-transitory computer-readable medium storing code for wireless communication at a network entity, the code comprising instructions executable by a processor to perform a method of any of aspects 18 through 34.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving a message that indicates a channel state information report configuration that identifies a quantity of channel state information reports to be transmitted by the UE:
generating, based at least in part on the channel state information report configuration, a full channel state information report and one or more partial channel state information reports, wherein the full channel state information report includes at least a set of spatial domain basis functions and a set of channel coefficients associated with the set of spatial domain basis functions, and wherein the one or more partial channel state information reports each include a respective set of differential channel coefficients; and
transmitting the quantity of channel state information reports, wherein the quantity of channel state information reports comprises the full channel state information report and the one or more partial channel state information reports.

2. The method of claim 1, wherein generating the full channel state information report and the one or more partial channel state information reports comprises:
receiving first signaling and second signaling over a channel for the wireless communication at the UE, the second signaling being received at the UE subsequent to the first signaling; and
generating the full channel state information report based at least in part on the first signaling and a first partial channel state information report of the one or more partial channel state information reports based at least in part on the second signaling, wherein the full channel state information report is transmitted over a first time occasion and the first partial channel state information report is transmitted over a second time occasion subsequent to the first time occasion.

3. The method of claim 2, wherein the first partial channel state information report includes a first set of differential channel coefficients and each differential channel coefficient of the first set of differential channel coefficients corresponds to a first channel coefficient difference relative to a respective channel coefficient of the set of channel coefficients.

4. The method of claim 3, wherein a number of bits used to represent each differential channel coefficient in the first partial channel state information report having a non-zero value is less than a number of bits used to represent respective channel coefficients in the full channel state information report.

5. The method of claim 3, further comprising:
receiving third signaling over the channel for the wireless communication at the UE, the third signaling being received at the UE subsequent to the second signaling;
generating a second partial channel state information report of the one or more partial channel state information reports based at least in part on the third signaling, wherein the second partial channel state information report includes a second set of differential channel coefficients and each differential channel coefficient of the second set of differential channel coefficients corresponds to a second channel coefficient difference relative to a respective differential channel coefficient of the first set of differential channel coefficients; and
transmitting the second partial channel state information report over a third time occasion subsequent to the second time occasion.

6. The method of claim 2, further comprising:
receiving another message configuring the UE with a first one or more resources for transmitting the full channel state information report over the first time occasion and a second one or more resources for transmitting the first partial channel state information report over the second time occasion.

7. The method of claim 2, further comprising:
receiving a first resource configuration indicating a first periodicity for transmitting a plurality of full channel state information reports, wherein the plurality of full channel state information reports comprises the full channel state information report, and wherein transmitting the full channel state information report over the first time occasion is based at least in part on the first resource configuration; and
receiving a second resource configuration indicating a second periodicity for transmitting the one or more partial channel state information reports, wherein transmitting the first partial channel state information report over the second time occasion is based at least in part on the second resource configuration, and wherein a first length of the first periodicity is different from a second length of the second periodicity.

8. The method of claim 2, wherein:
the channel state information report configuration indicates a plurality of resources for receiving the first signaling and the second signaling, and
the plurality of resources are periodic resources or semi-persistent resources, wherein receiving first signaling and second signaling further comprises:
receiving the first signaling over a first one or more resources of the plurality of resources and the second signaling over a second one or more resources of the plurality of resources based at least in part on the channel state information report configuration.

9. The method of claim 1, wherein:
the quantity of channel state information reports comprises a channel state information report group, and
the quantity of channel state information reports is identified based at least in part on a channel state information report group size indicated by the channel state information report configuration.

10. The method of claim 9, wherein:
the channel state information report configuration further indicates for each partial channel state information report included in the channel state information report group to be associated with the full channel state information report or a preceding partial channel state information report, and
generating the one or more partial channel state information reports is based at least in part on the channel state information report configuration.

11. The method of claim 9, further comprising:
receiving another message indicating a position of a channel state information report of the channel state information report group to be retransmitted by the UE, wherein the position corresponds to a first position associated with the full channel state information report or a second position associated with a partial channel state information report of the one or more partial channel state information reports; and
retransmitting the full channel state information report or the partial channel state information report based at least in part on the position.

12. The method of claim 1, wherein generating the full channel state information report and the one or more partial channel state information reports comprises:
receiving first signaling and second signaling over a channel for the wireless communication at the UE, the second signaling being received at the UE subsequent to the first signaling; and
generating the full channel state information report based at least in part on the second signaling and a first partial channel state information report of the one or more partial channel state information reports based at least in part on the first signaling.

13. The method of claim 12, wherein the first signaling and the second signaling comprise a reference signal transmission group, and wherein transmitting the quantity of channel state information reports comprises:
transmitting the full channel state information report and the first partial channel state information report in a group report for the reference signal transmission group.

14. The method of claim 13, wherein:
the channel state information report configuration comprises an indication of the reference signal transmission group, and
the quantity of channel state information reports is identified based at least in part on a size of the reference signal transmission group.

15. The method of claim 13, further comprising:
receiving third signaling over the channel for the wireless communication at the UE, the third signaling being received at the UE prior to the first signaling and the second signaling; and
generating a second partial channel state information report of the one or more partial channel state information reports based at least in part on the third signaling, wherein the full channel state information report, the first partial channel state information report, and the second partial channel state information report are transmitted in the group report for the reference signal transmission group, and wherein a number of bits included in the first partial channel state information report is greater than a number of bits included in the second partial channel state information report.

16. The method of claim 1, wherein:
the full channel state information report further comprises a set of frequency domain basis functions, and
the set of channel coefficients comprises a set of spatial frequency domain channel coefficients associated with the set of spatial domain basis functions and the set of frequency domain basis functions.

17. The method of claim 16, wherein a position of each differential channel coefficient of a set of differential channel coefficients corresponds to a same position or a different position as a respective spatial frequency domain channel coefficient of the set of spatial frequency domain channel coefficients.

18. A method for wireless communication at a network entity, comprising:
outputting a message that indicates a channel state information report configuration that identifies a quantity of channel state information reports to be transmitted by a user equipment (UE); and
obtaining the quantity of channel state information reports, wherein the quantity of channel state information reports comprises a full channel state information report that includes at least a set of spatial domain basis functions and a set of channel coefficients associated with the set of spatial domain basis functions and one or more partial channel state information reports that each include a respective set of differential channel coefficients.

19. The method of claim 18, further comprising:
outputting first signaling and second signaling over a channel for wireless communications with the UE, the second signaling being output subsequent to the first signaling, wherein the full channel state information report is based at least in part on the first signaling and a first partial channel state information report of the one or more partial channel state information reports is based at least in part on the second signaling, and wherein the full channel state information report is obtained over a first time occasion and the first partial channel state information report is obtained over a second time occasion subsequent to the first time occasion.

20. The method of claim 19, wherein the first partial channel state information report includes a first set of differential channel coefficients and each differential channel coefficient of the first set of differential channel coefficients corresponds to a first channel coefficient difference relative to a respective channel coefficient of the set of channel coefficients.

21. The method of claim 20, wherein a number of bits used to represent each differential channel coefficient in the first partial channel state information report having a non-zero value is less than a number of bits used to represent respective channel coefficients in the full channel state information report.

22. The method of claim 20, further comprising:
outputting third signaling over the channel for the wireless communications with the UE, the third signaling being output subsequent to the second signaling; and
obtaining a second partial channel state information report of the one or more partial channel state information reports based at least in part on the third signaling, wherein the second partial channel state information report includes a second set of differential channel coefficients and each differential channel coefficient of the second set of differential channel coefficients corresponds to a second channel coefficient difference relative to a respective differential channel coefficient of the first set of differential channel coefficients, and wherein the second partial channel state information report is obtained over a third time occasion subsequent to the second time occasion.

23. The method of claim 19, further comprising:
outputting another message configuring the UE with a first one or more resources for transmitting the full channel state information report over the first time occasion and a second one or more resources for transmitting the first partial channel state information report over the second time occasion.

24. The method of claim 19, further comprising:
outputting a first resource configuration indicating a first periodicity for transmitting, by the UE, a plurality of full channel state information reports, wherein the plurality of full channel state information reports comprises the full channel state information report, and wherein obtaining the full channel state information report over the first time occasion is based at least in part on the first resource configuration; and
outputting a second resource configuration indicating a second periodicity for transmitting, by the UE, the one or more partial channel state information reports, wherein obtaining the first partial channel state information report over the second time occasion is based at least in part on the second resource configuration, and wherein a first length of the first periodicity is different from a second length of the second periodicity.

25. The method of claim 19, wherein:
the channel state information report configuration indicates a plurality of resources for receiving the first signaling and the second signaling, and
the plurality of resources are periodic resources or semi-persistent resources, wherein outputting first signaling and second signaling further comprises:
outputting the first signaling over a first one or more resources of the plurality of resources and the second signaling over a second one or more resources of the plurality of resources based at least in part on the channel state information report configuration.

26. The method of claim 18, wherein:
the quantity of channel state information reports comprises a channel state information report group, and
the quantity of channel state information reports is identified based at least in part on a channel state information report group size indicated by the channel state information report configuration.

27. The method of claim 26, wherein:
the channel state information report configuration further indicates for each partial channel state information report included in the channel state information report group to be associated with the full channel state information report or a preceding partial channel state information report, and
the one or more partial channel state information reports are based at least in part on the channel state information report configuration.

28. The method of claim 18, further comprising:
outputting first signaling and second signaling over a channel for wireless communications with the UE, the second signaling being output subsequent to the first signaling, wherein the full channel state information report is based at least in part on the second signaling and a first partial channel state information report of the one or more partial channel state information reports is based at least in part on the first signaling.

29. A user equipment (UE) for wireless communication, comprising:
a processor;
memory coupled with the processor; and
instructions stored in the memory and executable by the processor to cause the UE to:
receive a message that indicates a channel state information report configuration that identifies a quantity of channel state information reports to be transmitted by the UE;
generate, based at least in part on the channel state information report configuration, a full channel state information report and one or more partial channel state information reports, wherein the full channel state information report includes at least a set of spatial domain basis functions and a set of channel coefficients associated with the set of spatial domain basis functions, and wherein the one or more partial channel state information reports each include a respective set of differential channel coefficients; and
transmit the quantity of channel state information reports, wherein the quantity of channel state information reports comprises the full channel state information report and the one or more partial channel state information reports.

30. A network entity for wireless communication, comprising:
a processor;
memory coupled with the processor; and
instructions stored in the memory and executable by the processor to cause the network entity to:
output a message that indicates a channel state information report configuration that identifies a quantity of channel state information reports to be transmitted by a user equipment (UE); and
obtain the quantity of channel state information reports, wherein the quantity of channel state information reports comprises a full channel state information report that includes at least a set of spatial domain basis functions and a set of channel coefficients associated with the set of spatial domain basis functions and one or more partial channel state information reports that each include a respective set of differential channel coefficients.
